(19) United States
(12) Patent Application Publication
(10) Pub. No.: US 2026/0155882 A1
(43) Pub. Date: Jun. 4, 2026

(54) QUASI CO-LOCATION (QCL) INFORMATION FOR SENSING

(71) Applicant: Lenovo (United States) Inc., Morrisville, NC (US)

(72) Inventors: Robin Rajan Thomas, Bad Nauheim (DE); Seyedomid Taghizadeh Motlagh, Oberursel (DE)

(73) Assignee: Lenovo (United States) Inc., Morrisville, NC (US)

(21) Appl. No.: 18/965,904

(22) Filed: Dec. 2, 2024

(51) Int. Cl. H04B 7/06; H04L 27/26

(52) U.S. Cl. CPC H04B 7/06968; H04L 27/261

(57) ABSTRACT

Various aspects of the present disclosure relate to quasi co-location (QCL) information for sensing. An apparatus (e.g., user equipment (UE), network equipment (NE)) receives configuration information indicating QCL relationship information between a source reference signal and a sensing reference signal. The apparatus receives the sensing reference signal based at least in part on a receive antenna configuration, where the receive antenna configuration is based at least in part on the configuration information including the QCL relationship information. The apparatus performs at least one sensing measurement based at least in part on the sensing reference signal.

### TECHNICAL FIELD

The present disclosure relates to wireless communications, and more specifically to sensing in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive configuration information indicating quasi co-location (QCL) relationship information between a source reference signal and a sensing reference signal; receive the sensing reference signal based at least in part on a receive antenna configuration, where the receive antenna configuration is based at least in part on the configuration information including the QCL relationship information; and perform at least one sensing measurement based at least in part on the sensing reference signal.

A processor (e.g., a standalone processor chipset, or a component of a UE) for wireless communication is described. The processor may be configured to, capable of, or operable to perform one or more operations as described herein. For example, the processor may be configured to, capable of, or operable to receive configuration information indicating QCL relationship information between a source reference signal and a sensing reference signal; receive the sensing reference signal based at least in part on a receive antenna configuration, where the receive antenna configuration is based at least in part on the configuration information including the QCL relationship information; and perform at least one sensing measurement based at least in part on the sensing reference signal.

A method performed or performable by a UE for wireless communication is described. The method may include receiving configuration information indicating QCL relationship information between a source reference signal and a sensing reference signal; receiving the sensing reference signal based at least in part on a receive antenna configuration, where the receive antenna configuration is based at least in part on the configuration information including the QCL relationship information; and performing at least one sensing measurement based at least in part on the sensing reference signal.

In some implementations of the UE, the processor, and the method described herein, the configuration information includes QCL relationship information for one or more of QCL type A, QCL type B, QCL type C, or QCL type D.

In some implementations of the UE, the processor, and the method described herein, the configuration information indicates one or more of: a first QCL type based at least in part on one or more of a spatial reception parameter, a spatial area, or a field-of-view parameter; or a second QCL type based at least in part on one or more of the spatial reception parameter, a target radar cross section, a target location information, a target orientation parameter, or a target mobility.

In some implementations of the UE, the processor, and the method described herein, the QCL relationship information is based at least in part on one or more of: a source reference signal of at least one of a dominant reflected signal path or a line of sight reflected signal path associated with a sensing target; or one or more reflected delay paths relative to a dominant reflected signal path or a line of sight reflected signal path associated with a sensing target.

In some implementations of the UE, the processor, and the method described herein, the source reference signal includes one or more downlink reference signals including one or more of a synchronization signal/physical broadcast channel (SS/PBCH) block (SSB) reference signal, a primary synchronization signal (PSS), a secondary synchronization signal (SSS), a channel state information reference signal (CSI-RS), a downlink positioning reference signal (DL-PRS), a tracking reference signal (TRS), a phase tracking reference signal (PT-RS), a demodulation reference signal (DM-RS) physical downlink control channel (PDCCH), or a DM-RS physical downlink shared channel (PDSCH) or downlink reference signal used for sensing.

In some implementations of the UE, the processor, and the method described herein, the source reference signal includes one or more uplink reference signals including one or more of multiple input multiple output (MIMO) sounding reference signal (SRS), a positioning SRS, a sensing SRS, or an uplink reference signal.

In some implementations of the UE, the processor, and the method described herein, the source reference signal includes one or more sidelink reference signals including one or more of a sidelink positioning reference signal (SL-PRS), a sidelink channel state information (SL-CSI), or a reference signal for a UE-UE link.

In some implementations of the UE, the processor, and the method described herein, the UE, the processor, and the method may further be configured to, capable of, operable to, performed to, or performable to receive transmission configuration indicator (TCI) configuration including one or more source reference signals with different QCL associations.

In some implementations of the UE, the processor, and the method described herein, the UE, the processor, and the method may further be configured to, capable of, operable to, performed to, or performable to receive TCI configuration including one or more source reference signals with different QCL associations defined based at least in part on frequency range of operation.

In some implementations of the UE, the processor, and the method described herein, the UE, the processor, and the method may further be configured to, capable of, operable to, performed to, or performable to request updated QCL information for sensing; and receive, in response to the requesting, the updated QCL information for sensing.

An NE (e.g., a base station) for wireless communication is described. The NE may be configured to, capable of, or operable to perform one or more operations as described herein. For example, the NE may be configured to, capable of, or operable to receive configuration information indicating QCL relationship information between a source reference signal and a sensing reference signal; receive the sensing reference signal based at least in part on a receive antenna configuration, where the receive antenna configuration is based at least in part on the configuration information including the QCL relationship information; and perform at least one sensing measurement based at least in part on the sensing reference signal.

A processor (e.g., a standalone processor chipset, or a component of a NE) for wireless communication is described. The processor may be configured to, capable of, or operable to perform one or more operations as described herein. For example, the processor may be configured to, capable of, or operable to receive configuration information indicating QCL relationship information between a source reference signal and a sensing reference signal; receive the sensing reference signal based at least in part on a receive antenna configuration, where the receive antenna configuration is based at least in part on the configuration information including the QCL relationship information; and perform at least one sensing measurement based at least in part on the sensing reference signal.

A method performed or performable by an NE (e.g., a base station) for wireless communication is described. The method may include receiving configuration information indicating QCL relationship information between a source reference signal and a sensing reference signal; receiving the sensing reference signal based at least in part on a receive antenna configuration, where the receive antenna configuration is based at least in part on the configuration information including the QCL relationship information; and performing at least one sensing measurement based at least in part on the sensing reference signal.

In some implementations of the NE, the processor, and the method described herein, the configuration information includes QCL relationship information for one or more of QCL type A, QCL type B, QCL type C, or QCL type D.

In some implementations of the NE, the processor, and the method described herein, the configuration information indicates one or more of: a first QCL type based at least in part on one or more of a spatial reception parameter, a spatial area, or a field-of-view parameter; or a second QCL type based at least in part on one or more of the spatial reception parameter, a target radar cross section, a target location information, a target orientation parameter, or a target mobility.

In some implementations of the NE, the processor, and the method described herein, the QCL relationship information is based at least in part on one or more of: a source reference signal of at least one of a dominant reflected signal path or a line of sight reflected signal path associated with a sensing target; or one or more reflected delay paths relative to a dominant reflected signal path or a line of sight reflected signal path associated with a sensing target.

In some implementations of the NE, the processor, and the method described herein, the NE, the processor, and the method may further be configured to, capable of, operable to, performed to, or performable to receive TCI configuration including one or more source reference signals with different QCL associations.

In some implementations of the NE, the processor, and the method described herein, the NE, the processor, and the method may further be configured to, capable of, operable to, performed to, or performable to receive TCI configuration including one or more source reference signals with different QCL associations defined based at least in part on frequency range of operation.

In some implementations of the NE, the processor, and the method described herein, the NE, the processor, and the method may further be configured to, capable of, operable to, performed to, or performable to request updated QCL information for sensing; and receive, in response to the requesting, the updated QCL information for sensing.

An NE (e.g., a base station) for wireless communication is described. The NE may be configured to, capable of, or operable to perform one or more operations as described herein. For example, the NE may be configured to, capable of, or operable to transmit configuration information indicating QCL relationship information between a source reference signal and a sensing reference signal.

A processor (e.g., a standalone processor chipset, or a component of a NE) for wireless communication is described. The processor may be configured to, capable of, or operable to perform one or more operations as described herein. For example, the processor may be configured to, capable of, or operable to transmit configuration information indicating QCL relationship information between a source reference signal and a sensing reference signal.

A method performed or performable by an NE (e.g., a base station) for wireless communication is described. The method may include transmitting configuration information indicating QCL relationship information between a source reference signal and a sensing reference signal.

In some implementations of the NE, the processor, and the method described herein, the NE, the processor, and the method may further be configured to, capable of, operable to, performed to, or performable to transmit the source reference signal; and transmit the sensing reference signal based at least in part on the configuration information including the QCL relationship information.

### BRIEF DESCRIPTION OF THE DRAWINGS

FIG. 1 illustrates an example of a wireless communications system in accordance with aspects of the present disclosure.

FIG. 2 illustrates an example wireless communications system for radio sensing that supports configuration for radio sensing in accordance with aspects of the present disclosure.

FIG. 3 illustrates an example wireless communications system for radio sensing that support configuration for radio sensing in accordance with aspects of the present disclosure.

FIG. 4 illustrates an example scenario for a tight coupling integrated sensing and communication (ISAC) network architecture.

FIG. 5 illustrates an example scenario for a tight coupling ISAC network architecture.

FIG. 6 illustrates an example scenario where a sensing function (SF) is collocated with the LMF.

FIG. 7 illustrates an example scenario for loose coupling ISAC network architecture.

FIG. 8 illustrates an example for transmit and echo pulse time domain representation.

FIG. 9 illustrates at example assistance data transfer operations for a positioning procedure.

FIG. 10 illustrates an example scenario for providing the first QCL condition to different entities.

FIG. 11 illustrates an example scenario for using the first QCL condition at different entities.

FIG. 12 illustrates an example scenario for providing the second QCL condition to different entities.

FIG. 13 illustrates an example scenario for using the second QCL condition at different entities.

FIG. 14 illustrates an example signaling diagram in accordance with aspects of the present disclosure.

FIG. 15 illustrates an example of a UE in accordance with aspects of the present disclosure.

FIG. 16 illustrates an example of a processor in accordance with aspects of the present disclosure.

FIG. 17 illustrates an example of a NE in accordance with aspects of the present disclosure.

FIG. 18 illustrates a flowchart of a method in accordance with aspects of the present disclosure.

FIG. 19 illustrates a flowchart of a method in accordance with aspects of the present disclosure.

FIG. 20 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In addition to wireless communication, time-frequency resources may be used for sensing, such as for object (e.g., human) detection, weather monitoring, automated guided vehicle (AGV) monitoring and tracking, automotive sensing, utilization of sensing and positioning information, etc. To enable accurate sensing, performance parameters can be specified, e.g., accuracy, resolution, latency, etc. The performance parameters, for instance, may be based on different sensing characteristics (e.g., radar cross section (RCS)) of one or multiple sensing target objects and/or an environment to be sensed in a target sensing service area. To support sensing, wireless communication networks can implement scenarios involving different radio access network (RAN) entities and UEs as sensing-related nodes. Some sensing and positioning frameworks enable a LMF to provide a RAN node, transmission-reception point (TRP), and/or NE with assistance information including an expected uplink (UL)-angle of arrival (AoA) and associated uncertainty range. In cases of sidelink (SL) positioning, a server UE can provide a target UE with assistance information relating to the expected SL-AoA and associated uncertainty range, where the AoAs can be expressed in terms of azimuth, zenith, or elevation.

Some sensing scenarios including an NE (e.g., base stations, TRPs, gNBs) or a UE acting as a sensing receive entity (sensing Rx entity) (e.g., TRP-TRP for TRP-TRP bistatic) involve a sensing system that includes information regarding a direction of a sensing target. Such information can mitigate issues in terms of performing beam sweeping and/or sensing scans in target areas which are not in an area of a target or detection/sensing area. Some wireless sensing systems, however, lack mechanisms for considering and indicating QCL relationships specifically for sensing that consider field of view and/or target characteristics (e.g., RCS), which can describe the relationship between receiving two reference signals (RSs) and/or a set of target reflection paths derived from two references signals with similar channel characteristics/statistics. One challenge is to avoid redundant estimation of channel characteristics/statistics of received reflected signals from a sensing target of two or more RSs with similar characteristics. A further challenge is that a sensing transmit entity (sensing Tx entity) or confirmation entity is to be enabled to inform the sensing Rx entities of the various QCL relationships between one or more pairs of source RS and target RS for sensing operations. A further challenge is that a sensing Rx entity may adapt its receiver characteristics (e.g., beamforming weights), which can affect the sensing scan behavior of the sensing Rx entity.

Aspects of the present disclosure are described in the context of a wireless communications system, and include implementations that provide different sensing-related QCL relationships which consider the nature of received reflected signal, e.g., based on the field of view information and/or target RCS characteristics. For instance, a QCL relationship for sensing is described which can be a function of a variety of channel characteristics of received reflected signal paths. A QCL relationship for sensing is also described as a function of the field of view information, which can include clutter, background channel characteristics, and/or statistics associated with a sensing target. A QCL relationship for sensing is also described as a function of sensing target-specific characteristics (e.g., RCS) which includes the sensing target and associated clutter, background channel characteristics, and/or statistics associated with a sensing target.

In implementations, a TCI framework is provided that can support associations of more than one source RS in different scenarios, e.g., based on the frequency range (FR) of the RS. For instance, a procedural framework is described to enable the exchange of existing and new QCL relationships as well as TCI information between a sensing configuration entity, sensing Tx entity, and sensing Rx entity. A TCI framework is described to enable dynamic indication of one or more source RSs based on RS type. Implementations described herein provide procedures for receiving new QCL relationships and according to new QCL indications and the TCI framework.

By performing the described techniques, a device in a wireless communications system can reduce signaling, processing overhead, and power usage as part of wireless sensing. For instance, the described QCL relationships and TCI framework modifications avoid burdening sensing Rx entities with re-estimation of channel characteristics of reflected received signals (e.g., delay spreads, angle-of-arrival spreads, doppler spreads, power information) that are received with similar properties based on two received RSs.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

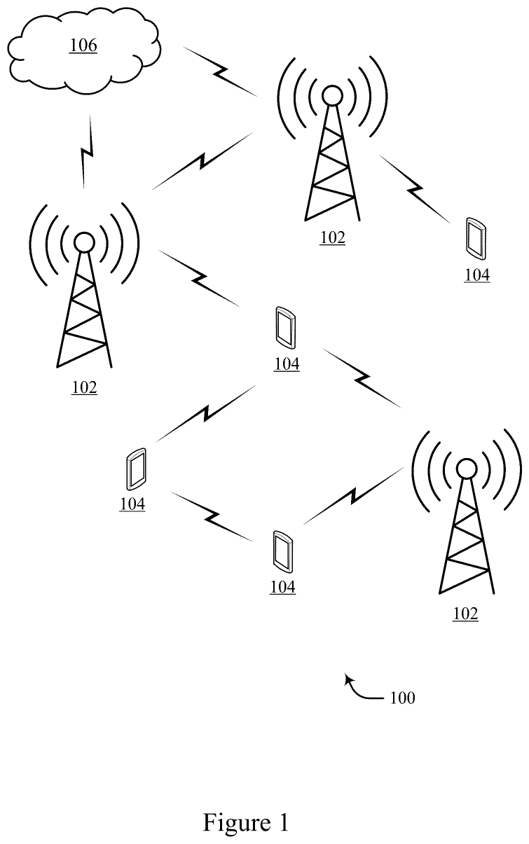

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a RAN, a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or TRPs.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. Reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 and/or UE 104 receives configuration information indicating QCL relationship information between a source reference signal and a sensing reference signal. The NE 102 and/or UE 104 receives the sensing reference signal based at least in part on a receive antenna configuration, where the receive antenna configuration is based at least in part on the configuration information including the QCL relationship information. The NE 102 and/or UE 104 performs at least one sensing measurement based at least in part on the sensing reference signal

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Example scenarios are discussed below for network-based and UE-based radio sensing operations. The scenarios include radio sensing where the network configures the participating sensing entities (e.g., network and UE nodes acting as sensing Tx entities, network and UE nodes acting as sensing Rx entities) as well as the configuration of sensing signals, measurements procedures, and reporting procedures from the participating sensing entities. A functional allocation between the network and the UE nodes for a specific sensing task (e.g., task of detecting presence of a pedestrian in a road) may take various forms, such as based on the availability of sensing-capable devices and the parameters of the specific sensing task.

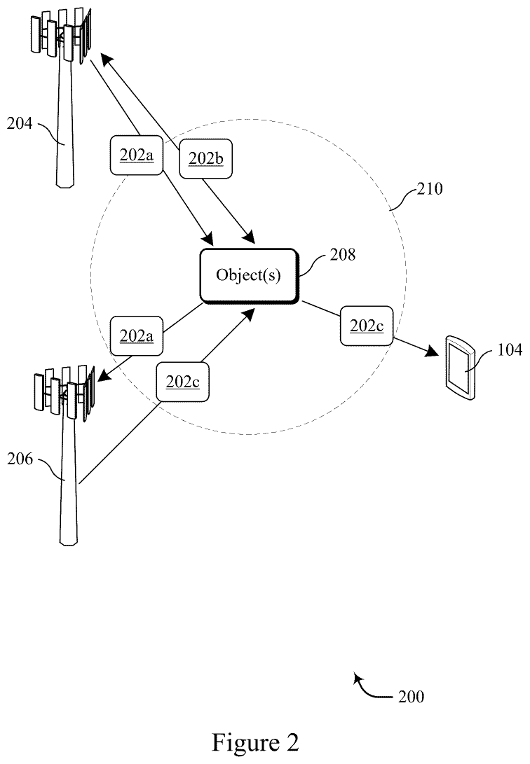

FIG. 2 illustrates an example wireless communication system 200 for radio sensing that supports configuration for radio sensing in accordance with aspects of the present disclosure. The wireless communication system 200 supports communication between UE 104, a first network node 204, and a second network node 206. The UE 104, the first network node 204, and the second network node 206 may communicate within an environment 210, e.g., a geographical area. The wireless communication system 200 may support a plurality of scenarios. The scenarios include:

Scenario 202a with a sensing Tx entity as a network node 204 and sensing Rx entity as a separate network node 206, which can represent different instances of NE 102: In the scenario 202a, the sensing reference signal (and/or another reference signal used for sensing or data and/or control channels known to the network TRP nodes) is transmitted and received by network entities 102. The involvement of UE nodes can be limited such as to aspects of interference management. The network may not utilize UEs for sensing assistance in the scenario 202a.

Scenario 202b with a sensing Tx entity as the network node 204 and sensing Rx entity as the same network node 204: In the scenario 202b, the sensing reference signal (and/or another reference signal used for sensing or the data and/or control channels known to the network TRP nodes) can be transmitted and received by the same network node 204, e.g., NE 102. The involvement of UE nodes can be limited such as to aspects of interference management. The network may not utilize UEs for sensing assistance in the scenario 202b.

Scenario 202c with a sensing Tx entity as the network node 206 and a sensing Rx entity as a UE 104: In the scenario 202c, the sensing reference signal or other reference signal used for sensing can be transmitted by the network node 206 (e.g., a NE 102) and received by one or multiple UEs 104. A network, for instance, configures the UE(s) 104 to act as a sensing Rx entity, such as according to the UE nodes capabilities for sensing and/or a specified sensing task.

As part of the scenarios 202a-202c, the radio sensing is implementing to detect feature characteristics of objects 208 present in an environment 210.

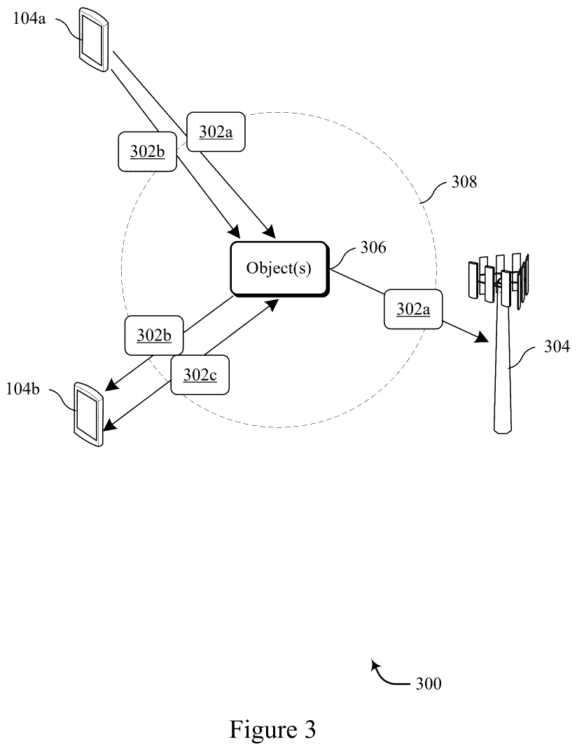

FIG. 3 illustrates an example wireless communication system 300 for radio sensing that support configuration for radio sensing in accordance with aspects of the present disclosure. The wireless communication system 300 supports communication between a UE 104a, a UE 104b, and a network node 304. The UE 104a, the UE 104b, and the network node 304 may communicate as part of detecting objects 306 within an environment 308, e.g., a geographical area. The scenarios depicted with reference to FIG. 2 and FIG. 3, for example, represent additional and/or alternative implementations. The wireless communication system 300 may support a plurality of scenarios. The scenarios include:

Scenario 302a with a sensing Tx entity as a UE 104a and sensing Rx entity as a network node 304: In the scenario 302a, the sensing reference signal or other reference signal used for sensing (and/or a data and/or control channel transmitted by the UE 104a) can be received by one or multiple NE 102 (e.g., the network node 304) and transmitted by the UE 104a. A network, for instance, configures the UE 104a to act as a sensing Tx entity, such as according to the UE 104a capabilities for sensing and/or a specified sensing task.

Scenario 302b with a sensing Tx entity as the UE 104a and a sensing Rx entity as a separate UE 104b: In the scenario 302b, the sensing reference signal or other reference signal used for sensing can be received by one or multiple UEs 104b and transmitted by the UE 104a. In this scenario, the network and/or a UE 104 may determine configuration for the sensing scenario. In at least one example, a network configures the UEs 104 to act as sensing Tx entities and/or sensing Rx entities, such as according to the UE 104 capabilities for sensing and/or a specified sensing task.

Scenario 302c with a sensing Tx entity as the UE 104b and sensing Rx entity as the same UE 104b: In the scenario 302c, the sensing reference signal (and/or another reference signal used for sensing and/or the data and/or control channels known to the UE) can be transmitted by the UE 104b and received by the same UE 104b. In at least one implementation, the UE 104b and/or a network configures the sensing scenario, such as according to the UE 104 capabilities for sensing and/or a specified sensing task.

The scenarios depicted herein are not intended to be restricted to a specific UE type, and may include any UE category. In the scenarios depicted herein, the roles elaborated for NE and/or UE may be replaced (with equal validity for any example of a radio sensing scenario) with any UE or RAN node, e.g., a smart repeater node, an integrated access and backhaul (IAB) node, a roadside unit (RSU), etc. In some examples, the set of sensing Tx entities of a sensing measurement process (and similarly, but optionally independently, sensing Rx entities of a sensing measurement process) include one or more of a TRP associated to a gNB-central unit (CU)/distributed unit (DU), a gNB-DU, a gNB-CU, a UE, a network controlled repeater (NCR), an IAB node, an RSU, or a dedicated sensing radio. In some implementations, a sensing Rx entity may be a non-3GPP sensor with capability of providing non-3GPP sensing data, or a 3GPP node (e.g., a UE or a RAN node) connected to the non-3GPP sensor that can obtain, process, and transfer the non-3GPP sensing data of the said non-3GPP sensor to other 3GPP nodes/entities.

Regarding sensing network architecture, integrated sensing and communication may enhance wireless (e.g., 5G) core architecture by introducing a new SF, such as discussed in the example scenarios below.

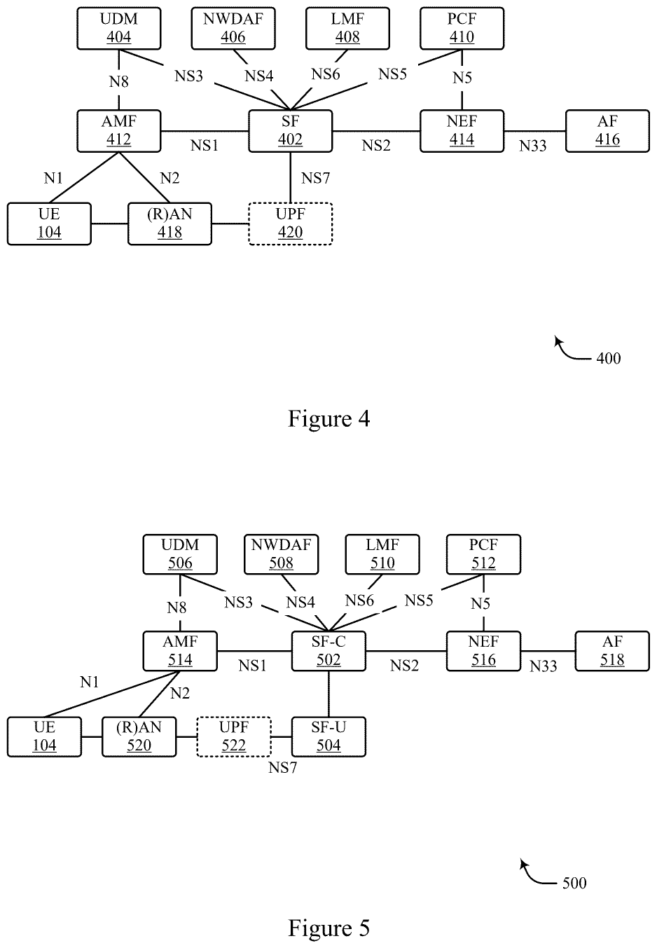

FIG. 4 illustrates an example scenario 400 for a tight coupling ISAC network architecture. The scenario 400 includes a SF 402, a unified data management (UDM) 404, a network data analytics function (NWDAF) 406, a LMF 408, a policy control function (PCF) 410, an access and mobility management function (AMF) 412, a network exposure function (NEF) 414, an application function (AF) 416, a UE 104, a RAN 418, and a UPF 420. Further, different reference points are illustrated with different “N” designations and represent interfaces between components of the scenario 400, such as reference point N1 between the UE 104 and the AMF 412, reference point N2 between the AMF 412 and the RAN 418, reference point N8 between the UDM 404 and the AMF 412, etc.

In the scenario 400 the SF 402 is implemented as a dedicated network function (NF) handling various tasks. For instance, the SF 402 can perform sensing control plane aspects such as the interaction with the sensing consumer via the NEF 414 and information exchange with other NFs, gathering UE 104 information, (e.g., from the AMF 412, UDM 404, LMF 408). The SF 402 can also obtain UE related policies from the PCF 410 and analytics from the NWDAF 406. The SF 402 may also manage the sensing radio signals for performing the analysis or prediction for determining a sensing target. With reference to the present disclosure, one or more entities in the scenario 400 can perform various implementations described herein for a configuration or sensing result entity and/or a measurement entity, such as the SF 402, nodes of the RAN 418, the UE 104, the LMF 408, etc.

FIG. 5 illustrates an example scenario 500 for a tight coupling ISAC network architecture. The scenario 500 includes a SF control plane (SF-C) 502, a SF user plane (SF-U) 504, a UDM 506, a NWDAF 508, an LMF 510, a PCF 512, an AMF 514, a NEF 516, an AF 518, a UE 104, a RAN 520, and a UPF 522. Further, different reference points are illustrated with different “N” designations and represent interfaces between components of the scenario 500, such as reference point N1 between the UE 104 and the AMF 514, reference point N2 between the AMF 514 and the RAN 520, reference point N8 between the UDM 506 and the AMF 514, etc.

In the scenario 500, a control plane/user plane (CP/UP) split is implemented where a SF has two dedicated NF counter parts: SF-C 502 that handles the control plane aspects as described above and SF-U 504 that is responsible for collecting the sensing radio signals via the user plane, e.g., via nodes of the RAN 520 and UPF 522. This architecture can split and offload heavy data volumes associated with sensing radio signals to the user plane to ensure light traffic (e.g., signaling) in the control plane. With reference to the present disclosure, one or more entities in the scenario 500 can perform various implementations described herein for a configuration or sensing result entity and/or a measurement entity, such as the SF-C 502, the SF-U 504, nodes of the RAN 520, the UE 104, the LMF 510, etc.

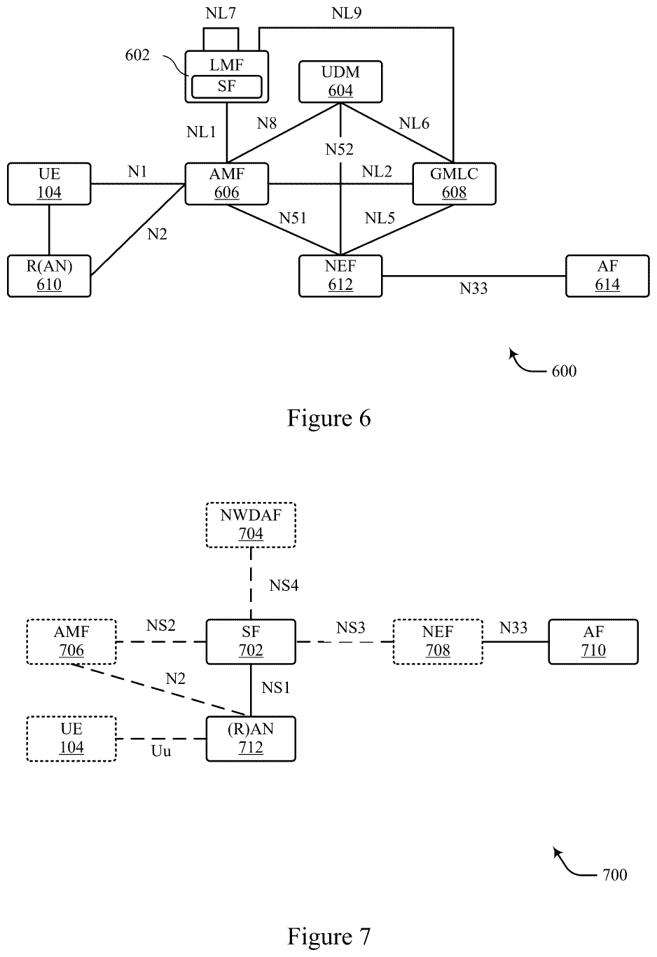

FIG. 6 illustrates an example scenario 600 where a SF is collocated with the LMF. The scenario 600 includes an SF/LMF 602, a UDM 604, a UE 104, an AMF 606, a gateway mobile location center (GMLC) 608, a RAN 610, a NEF 612, and an AF 614. Further, different reference points are illustrated with different “N” designations and represent interfaces between components of the scenario 600, such as reference point N1 between the UE 104 and the AMF 606, reference point N2 between the AMF 606 and the RAN 610, reference point N8 between the UDM 604 and the AMF 606, etc. In the scenario 600, the SF/LMF 602 is implemented as a logical NF embedded in the LMF to perform sensing taking advantage of the knowledge of the UE 104 location. With reference to the present disclosure, one or more entities in the scenario 600 can perform various implementations described herein for a configuration or sensing result entity and/or a measurement entity, such as the SF/LMF 602, nodes of the RAN 610, the UE 104, etc.

FIG. 7 illustrates an example scenario 700 for loose coupling ISAC network architecture. The scenario 700 includes a SF 702, a NWDAF 704, an AMF 706, a NEF 708, an AF 710, a UE 104, and a RAN 712. Further, different reference points are illustrated with different “N” designations and represent interfaces between components of the scenario 700, such as reference point N2 between the AMF 706 and the RAN 712, reference point NS2 between the SF 702 and the AMF 706, reference point NS3 between the SF 702 and the NEF 708, etc. In the scenario 700 the SF 702 is independent of the 5G core, e.g., the SF 702 can be used for local field scenarios or private networks and the interaction with the 5G core is minimal. One implementation is to use the SF 702 close to the RAN 712 (e.g., collect and process the sensing radio signals locally) and interact with 5G core for the purpose of exposure via the NEF 708, e.g., for obtaining the UE 104 location from the AMF 706 and for analytics, e.g., NWDAF 704. With reference to the present disclosure, one or more entities in the scenario 700 can perform various implementations described herein for a configuration or sensing result entity and/or a measurement entity, such as the SF 702, nodes of the RAN 712, the UE 104, etc.

In some example implementations, a sensing controller entity/function (e.g., sensMF, SMF, SF, SMC) is defined which includes one or multiple of a UE, a RAN node, a gNB/gNB-CU, an LMF, an SF, or a combination thereof. The sensMF can perform one or multiple of: (a) receiving requests for sensing information from a service consumer (e.g., a requesting third party application); (b) determining selection and/or configuration of a sensing operation, including configuration of one or more of a sensing Tx entity, sensing Rx entity; (c) selecting and/or configuring the involved nodes for sensing transmission and sensing reception and sensing measurement and reporting of the conducted measurements; (d) collecting the sensing measurements; (e) performing, configuring, and/or requesting computation of the sensing measurements and thereby determining sensing information based on the obtained sensing measurements; (f) reporting and/or exposing an obtained sensing information to the entity requesting the sensing information.

In some examples, a sensMF includes multiple nodes and/or entities, and one or more first aspects of the above-mentioned steps may be implemented by the first part of the sensMF and one or more second aspects of the above steps may be implemented by the second part of the sensMF, e.g., implemented in the SF and NE. In some examples, where the sensMF includes multiple nodes/entities, communication among the sensMF entities can be transparent to outside entities. Communication among the sensMF entities can be assumed to be implicit to the overall procedure. In some examples, where a sensMF is includes an SF and an NE (e.g., serving/head gNB of a related UE to the sensing task or a selected serving gNB for a sensing task), the SF can perform steps a, f, c, d (above) and the steps b, c can be performed by the selected NE, e.g., gNB node.

In some implementations the steps b, d above can be jointly performed by the SF and a selected NE (e.g., gNB), where a first aspect of the configuration/configuration determination can be performed by the SF and a second aspect of the configuration/configuration determination can be performed by the selected NE. The sensMF may be a RAN node (e.g., a selected gNB node acting as serving gNB of a sensing task), a SF residing in core network, a UE, and/or combinations thereof.

Communication and radar technologies have been deployed as separate/independent systems each with a separate waveform. There are, however, use cases (e.g., automotive, smart factory, medical monitoring, etc.) where joint radio communications and radar sensing using the same waveform are considered beneficial for efficient usage of the radio frequency (RF) spectrum as well usage of the same hardware to perform high data rate communications and precise ranging. Radar systems can be classified into the following categories: Monostatic radars: A radar system in which the transmitter and receiver are collocated; Bistatic radar: A radar system that includes a transmitter and receiver that are separated by a distance comparable to the expected target distance; Multistatic radar: A radar system which includes multiple spatially diverse monostatic radar or bistatic radar components within an overlapping coverage area.

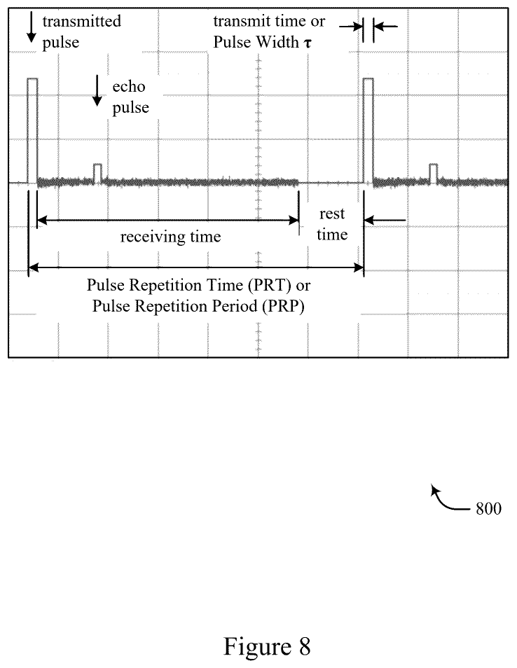

FIG. 8 illustrates an example 800 for transmit and echo pulse time domain representation. Radar signals are characterized by pulses that are modulated onto an RF carrier and are used to detect single/multiple objects that can be resolved in the time domain. In a scenario, for a single reflector, a pulse with measured round-trip time t allows the range (R) with respect to the object to be calculated as:

$$R = \frac{ct}{2}$$

While the range resolution (ΔR) is calculated as:

$$Δ R = \frac{c τ}{2}$$

Where τ is the pulse width and c is the speed of light. The radar pulses can be transmitted periodically so that range information can be provided in real time and wait for the returning echo signal during a rest/listening time (“rest time”) such as illustrated at 800.

With reference to RAT-dependent positioning measurements, different downlink (DL) measurements include DL-PRS-reference signal received power (RSRP), DL reference signal time difference (RSTD) and UE Rx-Tx Time Difference for the supported RAT-dependent positioning techniques are shown in Table 1. The following measurement configurations are specified: (1) 4 Pair of DL RSTD measurements can be performed per pair of cells. Each measurement is performed between a different pair of DL PRS Resources/Resource Sets with a single reference timing; (2) 8 DL PRS RSRP measurements can be performed on different DL PRS resources from the same cell.

TABLE 1
DL PRS-RSRP

| | |
|---|---|
| Definition | DL PRS-RSRP is defined as the linear average over the power contributions (in |
| | 14) of the resource elements that carry DL PRS reference signals configured for |
| | RSRP measurements within the considered measurement frequency bandwidth. |
| | For frequency range 1, the reference point for the DL PRS-RSRP may be the |
| | antenna connector of the UE. For frequency range 2, DL PRS-RSRP may be |
| | measured based on the combined signal from antenna elements corresponding |
| | to a given receiver branch. For frequency range 1 and 2, if receiver diversity is |
| | in use by the UE, the reported DL PRS-RSRP value may not be lower than the |
| | corresponding DL PRS-RSRP of any of the individual receiver branches. |
| Applicable for | RRC_CONNECTED intra-frequency, |
| | RRC_CONNECTED inter-frequency |

DL RSTD

| | |
|---|---|
| Definition | DL RSTD is the DL relative timing difference between the positioning node j |
| | and the reference positioning node i, defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe received |
| | from positioning node j. |
| | Multiple DL PRS resources can be used to determine the start of one subframe |
| | from a positioning node. |
| | For frequency range 1, the reference point for the DL RSTD may be the antenna |
| | connector of the UE. For frequency range 2, the reference point for the DL |
| | RSTD may be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement may be the |
| | Rx antenna connector of the UE and the reference point for T_{UE-TX} measurement |
| | may be the Tx antenna connector of the UE. For frequency range 2, the |
| | reference point for T_{UE-RX} measurement may be the Rx antenna of the UE and |
| | the reference point for T_{UE-TX} measurement may be the Tx antenna of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS-RSRPP is defined as the power of the linear average of the channel |
| | response at the i-th path delay of the resource elements that carry DL PRS |
| | signal configured for the measurement, where DL PRS-RSRPP for the 1st path |
| | delay is the power contribution corresponding to the first detected path in time. |
| | For frequency range 1, the reference point for the DL PRS-RSRPP may be the |
| | antenna connector of the UE. For frequency range 2, DL PRS-RSRPP may be |
| | measured based on the combined signal from antenna elements corresponding |
| | to a given receiver branch. |
| Applicable for | RRC_CONNECTED, |
| | RRC_INACTIVE |

UL AoA

| | |
|---|---|
| Definition | UL AoA is defined as the estimated azimuth angle (A-AoA) and vertical angle |
| | (zenith (Z)-AoA) of a UE with respect to a reference direction, where the |
| | reference direction is defined: |
| | In the global coordinate system (GCS), where estimated azimuth angle is |
| | measured relative to geographical North and is positive in a |
| | counterclockwise direction and estimated vertical angle is measured |
| | relative to zenith and positive to horizontal direction |
| | In the local coordinate system (LCS), where estimated azimuth angle is |
| | measured relative to x-axis of LCS and positive in a counter-clockwise |
| | direction and estimated vertical angle is measured relative to z-axis of |
| | LCS and positive to x-y plane direction. The bearing, downtilt and slant |
| | angles of LCS are defined according to 3GPP technical specification (TS) |
| | 38.901. |
| | The UL-AoA is determined at the gNB antenna for an UL channel |
| | corresponding to this UE. |

UL Relative Time of Arrival (T_{UL-RTOA})

| | |
|---|---|
| Definition | The T_{UL-RTOA} is the beginning of subframe i containing sounding reference |
| | signal (SRS) received in Reception Point (RP) j, relative to the RTOA |
| | Reference Time. |
| | The UL RTOA reference time is defined as T₀ + t_{SRS}, where |
| | T₀ is the nominal beginning time of system frame number (SFN) 0 |
| | provided by SFN Initialization Time [15, TS 38.455] |
| | t_{SRS} = (10n_{f} + n_{sf}) × 10⁻³, where n_{f} and n_{sf} are the system frame |
| | number and the subframe number of the SRS, respectively. |
| | Multiple SRS resources can be used to determine the beginning of one subframe |
| | containing SRS received at a RP. |
| | The reference point for T_{UL-RTOA} may be: |
| | for type 1-C base station TS 38.104: the Rx antenna connector, |
| | for type 1-O or 2-O base station TS 38.104: the Rx antenna (i.e. the center |
| | location of the radiating region of the Rx antenna), |
| | for type 1-H base station TS 38.104: the Rx Transceiver Array |
| | Boundary connector. |

gNB Rx − Tx time difference

| | |
|---|---|
| Definition | The gNB Rx − Tx time difference is defined as T_{gNB-RX} − T_{gNB-TX} |
| | Where: |
| | T_{gNB-RX} is the Transmission and Reception Point (TRP) received timing of |
| | uplink subframe #i containing SRS associated with UE, defined by the first |
| | detected path in time. |
| | T_{gNB-TX} is the TRP transmit timing of downlink subframe #j that is closest in |
| | time to the subframe #i received from the UE. |
| | Multiple SRS resources can be used to determine the start of one subframe |
| | containing SRS. |
| | The reference point for T_{gNB-RX} may be: |
| | for type 1-C base station TS 38.104: the Rx antenna connector, |
| | for type 1-O or 2-O base station TS 38.104: the Rx antenna (i.e. the center |
| | location of the radiating region of the Rx antenna), |
| | for type 1-H base station TS 38.104: the Rx Transceiver Array Boundary |
| | connector. |
| | The reference point for T_{gNB-TX} may be: |
| | for type 1-C base station TS 38.104]: the Tx antenna connector, |
| | for type 1-O or 2-O base station TS 38.104]: the Tx antenna (i.e. the |
| | center location of the radiating region of the Tx antenna), |
| | for type 1-H base station TS 38.104: the Tx Transceiver Array Boundary |
| | connector. |

UL SRS reference signal received path power (UL SRS-RSRPP)

| | |
|---|---|
| Definition | UL SRS-RSRPP is defined as the power of the linear average of the channel |
| | response at the i-th path delay of the resource elements that carry the received |
| | UL SRS signal configured for the measurement, where UL SRS-RSRPP for 1st |
| | path delay is the power contribution corresponding to the first detected path in |
| | time |
| | The reference point for UL SRS-RSRPP may be: |
| | for type 1-C base station TS 38.104 [9]: the Rx antenna connector, |
| | for type 1-O or 2-O base station TS 38.104 [9]: based on the combined |
| | signal from antenna elements corresponding to a given receiver branch |
| | for type 1-H base station TS 38.104 [9]: the Rx Transceiver Array |
| | Boundary connector. |
| | For frequency range 1 and 2, if receiver diversity is in use by the gNB for UL |
| | SRS-RSRPP measurements: |
| | The reported UL SRS-RSRPP value for the first and additional paths |
| | may be provided for the same receiver branch(es) as applied for UL SRS-RSRP |
| | measurements, or |
| | The reported UL SRS-RSRPP value for the first path may not be lower |
| | than the corresponding UL SRS-RSRPP for the first path of any of the |
| | individual receiver branches and the reported UL SRS-RSRPP for the additional |
| | paths may be provided for the same receiver branch(es) as applied UL SRS- |
| | RSRPP for the first path. |

Regarding UL-AoA assistance information, an information element (IE) can include UL AoA and uncertainty range, such as shown in Table 2.

TABLE 2

| | | | IE Type and | |
|---|---|---|---|---|
| IE/Group Name | Presence | Range | Reference | Semantics Description |
| CHOICE | M | | | |
| AngleMeasurement | | | | |
| >Expected UL Angle | | | | |
| of Arrival | | | | |
| >>Expected | | 1 | | Defined as |
| Azimuth AoA | | | | (φ_{AOA} − Δφ_{AOA}/2, φ_{AOA} + |
| | | | | Δφ_{AOA}/2) |
| >>>Expected | M | | INTEGER(0 . . . | φ_{AOA} component of |
| Azimuth AoA | | | 3599) | Expected Azimuth AoA |
| Value | | | | |
| >>>Expected | M | | INTEGER(0 . . . | Δφ_{AOA} component of |
| Azimuth AoA | | | 3599) | Expected Azimuth AoA |
| Uncertainty Range | | | | |
| >>Expected Zenith | | 0 . . . 1 | | Defined as |
| AoA | | | | (θ_{ZOA} − Δθ_{ZOA}/2, θ_{ZOA} + |
| | | | | Δθ_{ZOA}/2) |
| >>>Expected | M | | INTEGER(0 . . . | θ_{ZOA} component of |
| Zenith AoA Value | | | 1799) | Expected Zenith AoA |
| >>>Expected | M | | INTEGER(0 . . . | Δθ_{ZOA} component of |
| Zenith AoA | | | 1799) | Expected Zenith AoA |
| Uncertainty Range | | | | |
| >Expected UL Angle | | | | Defined as |
| of Arrival Zenith | | | | (θ_{ZOA} − Δθ_{ZOA}/2, θ_{ZOA} + |
| Only | | | | Δθ_{ZOA}/2) |
| >>Expected Zenith | M | | INTEGER(0 . . . | θ_{ZOA} component of |
| AoA Value | | | 1799) | Expected Zenith AoA |
| >>Expected Zenith | M | | INTEGER(0 . . . | Δθ_{ZOA} component of |
| AoA Uncertainty | | | 1799) | Expected Zenith AoA |
| Range | | | | |
| LCS to GCS | O | | 9.2.69 | If absent, the azimuth and |
| Translation | | | | zenith are provided in |
| | | | | GCS. In case of zenith |
| | | | | only, the z-axis of LCS is |
| | | | | defined along the linear |
| | | | | array axis. |

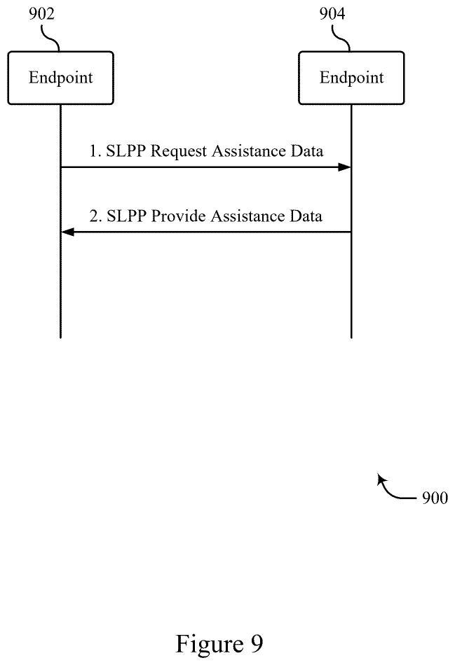

FIG. 9 illustrates at 900 example assistance data transfer operations for a positioning procedure. The scenario 900, for example, represents example assistance data transfer operations for SL-AoA for a positioning procedure. At (1) endpoint 902 may determine that SL-AoA positioning assistance data is to be obtained and sends a SL positioning protocol (SLPP) Request Assistance Data message to endpoint 904. This request includes an indication of which specific SL-AoA assistance data are requested.

At (2) endpoint 904 can provide the requested assistance in an SLPP Provide Assistance Data message to endpoint 902. Examples of the assistance data that may be signaled are listed in Table 3 below. If any of the requested assistance data in step (1) are not provided in step (2), endpoint 902 can assume that the requested assistance data are not supported, or currently not available at the endpoint 904. If none of the requested assistance data in step (1) can be provided by the endpoint 904, the endpoint 904 can return information that can be provided in an SLPP message of type Provide Assistance Data which includes a cause indication for the not provided assistance data. If step (1) did not occur, endpoint 904 can determine that SL-AoA assistance data is to be provided to endpoint 902 (e.g., as part of a positioning procedure) and can send an SLPP Provide Assistance Data message to endpoint 902.

Endpoint 902 may be a SL Target UE and endpoint 904 may be a SL Server UE or LMF. Alternatively, or additionally, endpoint 902 may be a SL Target UE or SL Server UE and endpoint 904 may be a SL Anchor UE. Alternatively or additionally, endpoint 902 may be a SL-PRS transmitting (Tx) UE and endpoint 904 may be a SL-PRS receiving (Rx) UE.

TABLE 3
Information

Application Layer identifier (ID), identifying a UE as
defined in TS 23.287, for which the assistance data are
applicable
SL-PRS Sequence ID as defined in TS 38.211
Anchor UE location coordinates
SL-PRS Tx antenna reference point (ARP) location
coordinates
SL-PRS Tx Information (SL-PRS Priority, SL-PRS
Delay Budget, SL-PRS Bandwidth, SL-PRS Periodicity,
SL-PRS Tx trigger indication)
Association information between SL-PRS Tx ARP-ID
and the already transmitted SL PRS resource(s)
Expected AoA and uncertainty

In aspects of this disclosure, solutions are provided for enabling a sensing Rx entity to support operation by receiving assistance information relating to QCL relationship information, field of view information, and beam sweep limit and/or scan limit (referred to herein as “beam sweep/scan limit”) information. In implementations, field of view information can include information regarding attributes of sensing Rx signal to be received at a sensing Rx entity, such as different angular information and/or estimated direction information for sensing objects that reflect sensing Tx signals to generate sensing Rx signals. For instance, solutions are provided to define QCL relationship between a source RS and a sensing RS, e.g., an RS used for sensing purposes. Solutions are also provided to define new QCL relationships between a source RS and a sensing RS, which can be defined based on the field of view information capturing sensing target, background, and/or channel characteristics. Solutions are also provided to define new QCL relationships between a source RS and a sensing RS which can be based on sensing target-specific characteristics. Solutions are also provided to define procedural frameworks to support the exchange of the new QCL relationship types as well as TCI indications between a sensing configuration entity, sensing Tx entity, and sensing Rx entity.

The implementations described herein may be implemented in combination with each other to support an enhanced and coordinated method to perform sensing measurements. For the purposes of this disclosure, reference made to position information, location information, and/or estimates thereof may refer to an absolute position, relative position with respect to another node/entity, ranging in terms of distance, ranging in terms of direction, or combinations thereof. A sensing result may be delivered to an entity (e.g., sensing result consumer) such as an application function or service consumer upon a triggered request. For the purposes of this disclosure, derivation of sensing information and/or sensing result can be based on the initial measurements and input parameters, which may be different from the generated/reported sensing radio measurements.

As discussed herein, a sensing management function (SMF) and/or SF can manage coordination and scheduling of resources for sensing an object, e.g., a human and/or other physical object. The SMF/SF can calculate and/or verify a sensing result and/or velocity or doppler estimates, and may estimate the achieved sensing accuracy. The SMF/SF can receive sensing requests for a target within a network area by a sensing client, which may be external or internal to a network or device, respectively. The SMF/SF can interact with various network entities and UEs to exchange location information applicable to UE assisted and UE based sensing methods, and can interact with a RAN (e.g., NG-RAN) to obtain sensing information. The SMF/SF, for example, is an example of a sensing result computation entity. A sensing management component (SMC) can represent all or part of the SMF/SF. The SMC may reside in the RAN, and is another example of a sensing result computation entity.

Implementations described herein include procedures for determining doppler and velocity information of one or more targets in a wireless communication network. The implementations, for example, cover different use cases and scenarios in which sensing of one or more targets may be performed depending on different factors such as: (1) the wireless communication entity/node configuring the reference signal for sensing and/or communication purposes; (2) the wireless communication entity/node transmitting the reference signal; (3) the wireless communication entity/node receiving the reference signal and performing the measurement of the received reference signal; (4) the wireless communication entity/node computing/determining the relevant sensing/radar metrics. Various combinations of wireless communication entities or nodes may be implemented to perform the described tasks based at least in part on the sensing scenarios, e.g., as illustrated in Table 4 below.

TABLE 4

| Scenario | Sensing Type | Description |
|---|---|---|
| TRP-TRP | Monostatic | A TRP of a gNB acts as a Sensing Transmitter while the same |
| | | TRP acts as Sensing Receiver. Also includes the case the quasi- |
| | | monostatic case, where a different TRP of the same gNB may |
| | | act as a sensing receiver, in which half-duplex operations are |
| | | supported. |
| UE-UE | Monostatic | A UE may act as a Sensing Transmitter while the same UE acts |
| | | as Sensing Receiver. |
| TRP-TRP | Bistatic | A TRP of a gNB acts as a Sensing Transmitter while another |
| | | TRP from different/neighboring gNB acts as a Sensing Receiver. |
| UE-UE | Bistatic | A UE acts as a Sensing Transmitter while another UE acts as a |
| | | Sensing Receiver. |
| TRP-UE | Bistatic | A TRP of a gNB acts as a Sensing Transmitter while a UE acts |
| | | as a Sensing Receiver. This UE may be served by the same gNB |
| | | acting as a Sensing Transmitter or different gNB. |
| UE-TRP | Bistatic | A UE acts as a Sensing Transmitter while a UE acts as a Sensing |
| | | Receiver. This UE may be served by the same gNB acting as a |
| | | Sensing Transmitter or different gNB. |

In implementations, one or more targets to be sensed may be categorized as follows: (1) device-free/passive—target includes an object not associated with the 3GPP network; (2) device-based/active—target is a human/object embedded with a UE, e.g., human holding a UE, UE embedded with a UAV, UE within automotive vehicles, etc.

Implementations include solutions for QCL associated with a received reflected sensing target or sensing area, e.g., sensing Tx entity configuration and RSs which can be QCLed for reflected paths. For instance, a new type of QCL framework may be defined and configured based on isotropically radiated power from one or more targets. RCS represents a parameter of target characteristics, which describes the area intercepting the amount of power which, if radiated isotropically, produces approximately a same received power profile at the receiver. A mathematical model for RCS is given by:

$${σ}_{RCS} = 4 π {R}^{2} \frac{{\vert {E}_{s} \vert}^{2}}{{\vert {E}_{i} \vert}^{2}} , \qquad ( 1 )$$

where R is the target-sensing Rx distance, Eₛ is the scattered field strength at sensing Rx, Eᵢ is the incident field strength at target.

In some beam management procedures (e.g., in LTE), one assumption is that transmitted reference signals originate from a same TRP, while in other beam management procedures (e.g., in NR), multiple TRPs may transmit a reference signal. In such procedures, a QCL framework was developed to create an association of channel statistics for antenna ports which are QCL′d if the channel of over which one symbol (e.g., reference signal symbol) is conveyed can be inferred from a channel over which a symbol (e.g., reference signal symbol) from another antenna port is conveyed. This association of channel statistics can be performed between a transmitter (e.g., base station) and receiver (e.g., UE) to perform beam correspondence and enable the receiver to estimate the parameters for estimating the channel statistics and properties, e.g., doppler shift, doppler spread, delay spread, average delay spread, spatial Rx parameters, e.g., AoA, dominant AoA, average AoA and so forth. The following QCL relationships have been defined including: QCL Type A: Doppler shift, Doppler spread, Delay Spread, Average Delay; QCL Type B: Doppler shift, Doppler spread; QCL Type C: Doppler shift, Average Delay Spread; QCL Type D: Spatial Rx Parameter.

QCL Types A, B and C can be applicable to all frequency ranges, while QCL Type D can be applicable to FR2 and FR3, where a UE can perform Rx beamforming. In the case of sensing operations, the sensing Rx entity can perform Rx beamforming according to the field of view information or scan limits relative to the approximate or precise known location information of the one or more target. Implementations can provide information regarding the channel statistics and properties of reference signals transmitted from two antenna ports which are QCL′d with respect to the projected cross section, reflectivity, and directivity properties of a sensing target, which are to be measured at the sensing Rx entity. A network can inform the sensing Rx entity if there is a change in the Tx beam conveying an RS for sensing purposes, e.g., new sensing RS, PRS, SRS, SRS for positioning, etc.

In implementations, if a sensing Rx entity receives an indication of a particular QCL indication (e.g., as defined herein, e.g., QCL type A), the sensing Rx entity may determine that the doppler shift, doppler spread, delay spread, and/or average delay of two different received reflected RS signals with respect to a sensing target are the same. The sensing Rx entity may thus use the same doppler shift, doppler spread, delay spread, average delay associated with the first reflected RS signal and apply it to the second reflected RS signal, without the sensing Rx entity redetermining the channel parameters such as doppler shift, doppler spread, delay spread, average delay characteristics of the second reflected RS signal.

In implementations, if a sensing Rx entity receives an indication of a particular QCL indication (e.g., as defined herein, e.g., QCL type D), the sensing Rx entity may determine to receive two different reflected RS signals with respect to a sensing target using the same Rx beamforming characteristics and/or same Rx spatial filter. This can indicate that the sensing Rx entity can maintain its scan limits and/or field of view information of the sensing area of the sensing target. For instance, the sensing Rx entity may use the same Rx spatial filter associated with the first reflected RS signal and apply it to the second reflected RS signal, without the sensing Rx entity having to redetermine another spatial filter (also known as beamforming weights) of the second reflected RS signal. Such implementations can provide a significant saving in terms of sensing Rx processing in terms of re-estimating channel statistics/channel properties of a received reflected signal with respect to a sensing target. Coordination of this information can be enabled with a configuration entity/sensing result computation entity that provides the QCL characteristics to the sensing Rx entity, and a sensing Tx entity may provide the QCL characteristics directly to the sensing Rx entity.

Implementations also provide a QCL type based on field of view information. For instance, a new type of QCL condition is described in the context of sensing operations and based on the field of view information of the sensing Rx entity. This QCL type can cover target channel characteristics, clutter characteristics, background channel characteristics, and/or statistics based on a particular field of view of the sensing Rx entity. The sensing Rx entity can be informed of the new QCL conditions when the sensing Tx entity changes a Tx beam between the sensing Tx entity and the sensing target, which can affect the reflected signal between the sensing target and the sensing Rx entity. The configuration entity/sensing result computation entity (e.g., SF, LMF, sensing Tx entity) can inform the sensing Rx entity with different information including new QCL information, RS beam spatial information, RS azimuth, zenith and/or elevation angle of departure (AoD), average AoD in terms of azimuth, zenith and/or elevation, power/delay AoD profile (including power angle profile and/or angle delay spectrum) in terms of azimuth, zenith and/or elevation as well as spatial Rx properties of the reflected signal subject to the same target location information, RCS and orientation, and combinations thereof. To enable such implementations, the sensing Rx entity may provide/report one or more types of RS AoA to the configuration entity/sensing result computation entity, including, e.g., RS azimuth, zenith and/or elevation AoA, average AoA in terms of azimuth, zenith and/or elevation, power/delay AoA profile (including power angle profile and/or angle delay spectrum), etc.

In implementations, a new QCL condition (e.g., “QCL Type E”, referred to herein as “first QCL condition”) may be defined, which characterizes the channel statistics/properties of reference signals transmitted from two or more antenna ports and corresponding reflected paths originating from the two or more antenna ports according to a same spatial area/field of view information. For instance, the first QCL condition can include a spatial Rx, spatial area/field of view parameter. If a sensing Rx entity receives an indication of the first QCL condition, the sensing Rx entity may determine that that the sensing Rx entity can receive two different received reflected RS signals with respect to a sensing target using the same Rx beamforming characteristics and/or same Rx spatial filter, and according to the same area or field of view information of the sensing target. For instance, the sensing Rx entity may use the same Rx spatial filter associated with the first reflected RS signal (e.g., RS1) and apply it to the second reflected RS signal (e.g., RS2) without the sensing Rx entity redetermining another spatial filter (also known as beamforming weights) of the second reflected RS signal corresponding the same sensing target. In this example, RS1 and RS2 can be different RS (non-overlapping) and may include SSB including synchronization signal (SS)-RS, CSI-RS, DL-PRS, MIMO SRS, SRS for positioning, new sensing RS, TRS, PT-RS, control DM-RS, data DM-RS, etc. RS1 may be referred to as the source RS for sensing while RS2 may be referred to as the target RS for sensing in the context of the QCL conditions.

In implementations, the source RS (e.g., RS1) may be DL-PRS associated with a Tx beam 1, of which the dominant/line of sight (LOS) reflected signal path off the sensing target can be received based on a DL-PRS Rx beam 1. If a new sensing RS (e.g., RS2) is QCLed based on the first QCL condition, the sensing Rx entity may use the same DL-PRS Rx beam 1 properties/spatial filter according to the field of view information/expected AoA of the DL-PRS beam 1 and apply it to receive the new sensing RS dominant/LOS reflected signal path off the sensing target.

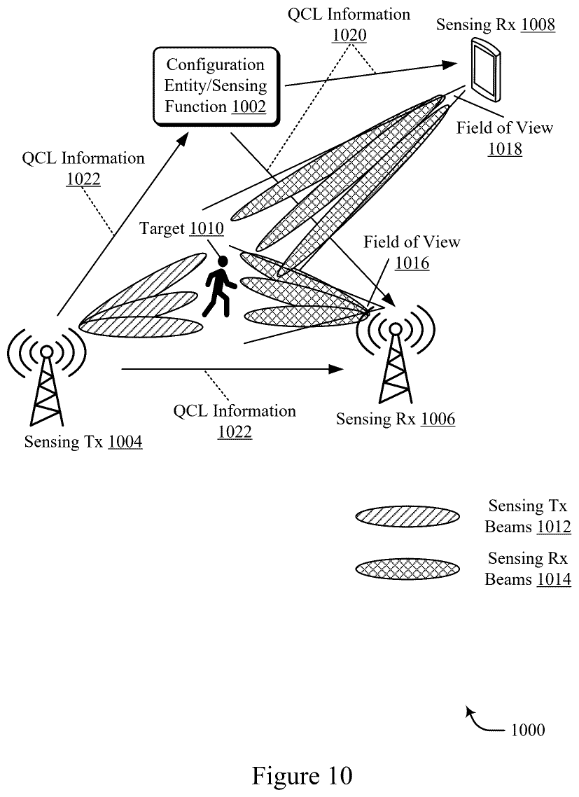

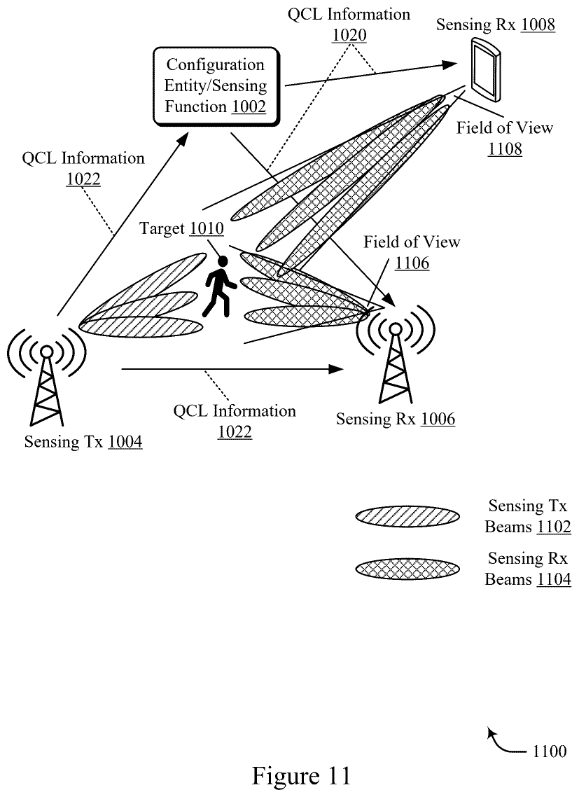

FIGS. 10 and 11 illustrate example scenarios in accordance with aspects of the presents disclose. FIG. 10, for instance, illustrates an example scenario 1000 for providing the first QCL condition to different entities. The scenario 1000 includes a configuration entity/sensing function 1002, a sensing Tx entity 1004, a sensing Rx entity 1006, a sensing Rx entity 1008, and a sensing target 1010. The sensing Tx entity 1004 can transmit sensing Tx beams 1012 and the sensing Rx entity 1006, sensing Rx entity 1008 can receive sensing Rx beams 1014. The sensing Tx beams 1012, for instance, are reflected off the sensing target 1010 and received by the sensing Rx entity 1006, sensing Rx entity 1008 as the sensing Rx beams 1014. In implementations, the sensing Tx beams 1012 and the sensing Rx beams 1014 represent first RS signals, e.g., RS1. The sensing Rx entity 1006 includes a field of view 1016 for the sensing Rx beams 1014 and the sensing Rx entity 1008 includes a field of view 1018 for the sensing Rx beams 1014.

In implementations, QCL information can be provided to different entities in different ways. For instance, the configuration entity/sensing function 1002 can provide QCL information 1020 including the first QCL condition based on field of view information to the sensing Rx entity 1006 and/or the sensing Rx entity 1008. In another example, the sensing Tx entity 1004 can provide QCL information 1022 including the first QCL condition based on field of view information to different entities, including the configuration entity/sensing function 1002, the sensing Rx entity 1006, and/or the sensing Rx entity 1008.

FIG. 11 illustrates an example scenario 1100 for using the first QCL condition at different entities. The scenario 1100, for example, can be implemented concurrently with and/or as a continuation of the scenario 1000 where first QCL condition information is provided to and/or received at the sensing Rx entities 1006, 1008. The sensing Tx entity 1004 can transmit sensing Tx beams 1102 and the sensing Rx entity 1006, sensing Rx entity 1008 can receive sensing Rx beams 1104. The sensing Tx beams 1102, for instance, are reflected off the sensing target 1010 and received by the sensing Rx entity 1006, sensing Rx entity 1008 as the sensing Rx beams 1104. In implementations, the sensing Tx beams 1102 and the sensing Rx beams 1104 represent second RS signals, e.g., RS2. The sensing Rx entity 1006 includes a field of view 1106 for the sensing Rx beams 1104 and the sensing Rx entity 1008 includes a field of view 1108 for the sensing Rx beams 1104.

In implementations and based on the QCL information 1020 and/or the QCL information 1022 indicating the first QCL condition, the sensing Rx entity 1006 can determine that the field of view 1106 for the sensing Rx beams 1104 (e.g., RS2) is approximately the same as the field of view 1016 for the sensing Rx beams 1014, e.g., RS1. Further, and based on the QCL information 1020 and/or the QCL information 1022 indicating the first QCL condition, the sensing Rx entity 1008 can determine that the field of view 1108 for the sensing Rx beams 1104 (e.g., RS2) is approximately the same as the field of view 1018 for the sensing Rx beams 1014, e.g., RS1.

In implementations, the reflected sensing Rx beams 1014 (RS1) and/or sensing Rx beams 1104 (RS2) off the sensing target 1010 may be associated via QCL to subsequent delay paths relative to the dominant/LOS reflected signal path, which may be earlier or later with the respect to the dominant/LOS reflected signal path. In this implementation, a configuration may further indicate which of the reflected non-LOS/dominant delay paths the source RS is associated with.

In implementations, the QCL types discussed herein and/or associations between two radiation pattens can be indicated with respect to a combination of a sensing target and/or an area of interest for sensing and a physical segment description of the sensing target/area of interest. For instance, the segmentation can include a range of sweeping parameters (e.g., defined steps in x, y direction) according to the GCS or the LCS of a sensing Tx entity and/or sensing Rx entity. In at least some examples, the segmentation can be defined in zenith/elevation domain. In at least some examples, the segmentation can be defined according to a known target segmentation pattern, e.g., human body parts or vehicle physical segments.

In implementations, a new QCL condition (e.g., “QCL Type F”, referred to herein as “second QCL condition”) may be defined in the context of sensing operations and based on the sensing target properties. For instance, these channel effects/characteristics may be induced by the target to be sensed (e.g., target channel) while in other implementations, these channel effects/characteristics may be induced by a combination of both the target channel and background channel (e.g., channel without the presence of the target). The sensing target properties, for instance, include target channel characteristics, clutter characteristics, background channel characteristics, and/or statistics based on target characteristics according to a sensing Rx entity. A sensing Rx entity, for instance, can be informed of the second QCL condition when a sensing Tx entity changes it's Tx beam between the sensing Tx entity and the sensing target, which can affect the reflected signal between the sensing target and the sensing Rx entity. The configuration entity/sensing result computation entity (e.g., SF, LMF, or sensing Tx entity) can inform the sensing Rx entity of the second QCL condition information, RS beam spatial information, RS azimuth, zenith and/or elevation AoD, average AoD in terms of azimuth, zenith and/or elevation, power/delay AoD profile (including power angle profile and/or angle delay spectrum) in terms of azimuth, zenith and/or elevation as well as spatial Rx properties of the reflected signal subject to the same target location information, RCS and orientation, and combinations thereof. To enable such implementations, the sensing Rx entity may provide/report one or more types of RS AoA to the configuration entity/sensing result computation entity, including, e.g., RS azimuth, zenith and/or elevation AoA, average AoA in terms of azimuth, zenith and/or elevation, power/delay AoA profile (including power angle profile and/or angle delay spectrum), etc.

In implementations, the second QCL condition can characterize the channel statistics and/or properties of reference signals transmitted from two or more antenna ports and corresponding reflected paths originating from the two or more antenna ports according to the same target RCS, including mean RCS, RCS distribution, target location information, target orientation, target mobility. The second QCL condition, for instance, can include spatial Rx, target RCS, target location information, target orientation parameters, and/or target mobility. If a sensing Rx entity receives an indication of the second QCL condition, the sensing Rx entity may determine that it can receive two different reflected RS signals with respect to the sensing target using the same Rx beamforming characteristics or same Rx spatial filter, according to the same area or field of view information of the one or more targets with the same location information, RCS, orientation and mobility, and combinations thereof. For instance, the sensing Rx entity may use the same Rx spatial filter associated with the first reflected RS (e.g., RS1) signal and apply it to the second reflected RS (e.g., RS2) without the sensing Rx entity redetermining another spatial filter (also known as beamforming weights) of the second reflected RS signal corresponding the same sensing target. In this example RS1 and RS2 can be different RS (non-overlapping) and may include SSB such as SS-RS, CSI-RS, DL-PRS, MIMO SRS, SRS for positioning, new sensing RS, TRS, PT-RS, control DM-RS, data DM-RS or reference signal used for sensing. RS1 may be referred to as the source RS for sensing while RS2 may be referred to as the target RS for sensing in the context of the QCL conditions.

In implementations, the source RS (RS1) may be SSB or CSI-RS associated to a Tx beam 1, of which the dominant/LOS reflected signal path off the sensing target is received based on a SSB or CSI-RS Rx beam 1. If a new RS for sensing purposes (e.g., new sensing RS or DL-PRS (RS 2)) is QCLed based on the second QCL condition, the sensing Rx entity may use the same SSB or CSI-RS Rx beam 1 properties/spatial filter according to the target RCS including mean RCS, RCS distribution, target location information, target orientation, target mobility of the DL-SSB or CSI-RS beam 1 and apply the beam 1 properties/spatial filter to receive the RS for sensing purposes, e.g., new sensing RS, dominant/LOS reflected signal path off the target, etc.

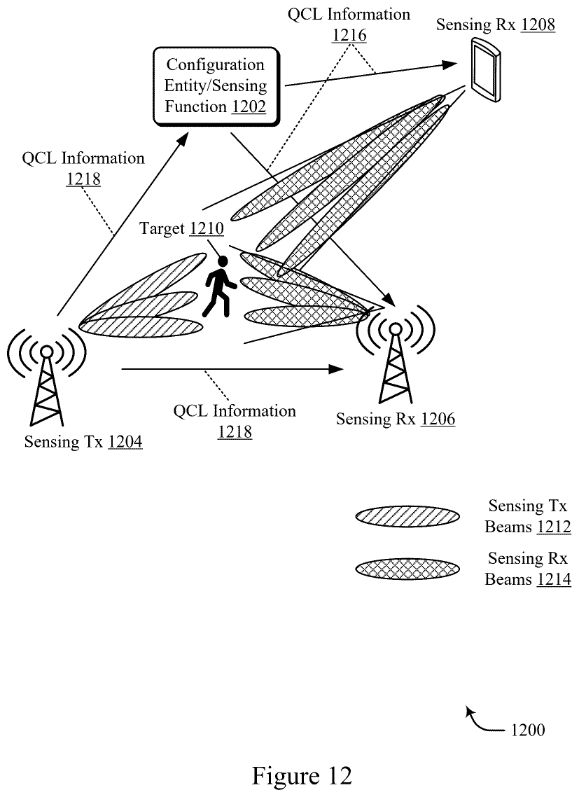

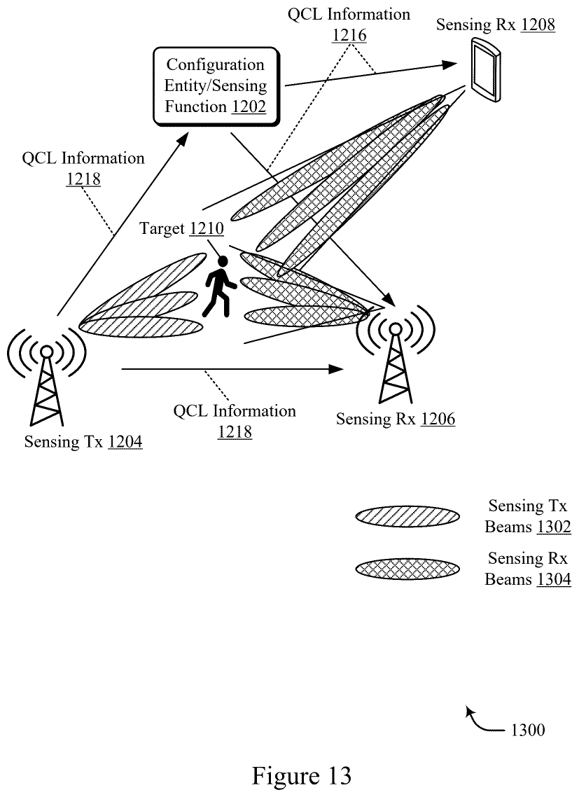

FIGS. 12 and 13 illustrate example scenarios in accordance with aspects of the presents disclose. FIG. 12, for instance, illustrates an example scenario 1200 for providing the second QCL condition to different entities. The scenario 1200 includes a configuration entity/sensing function 1202, a sensing Tx entity 1204, a sensing Rx entity 1206, a sensing Rx entity 1208, and a sensing target 1210. The sensing Tx entity 1204 can transmit Tx beams 1212 and the sensing Rx entity 1206, sensing Rx entity 1208 can receive sensing Rx beams 1214. The sensing Tx beams 1212, for instance, are reflected off the sensing target 1210 and received by the sensing Rx entity 1206, sensing Rx entity 1208 as the sensing Rx beams 1214. In implementations, the sensing Tx beams 1212 and the sensing Rx beams 1214 represent first RS signals, e.g., RS1.

In implementations, QCL information can be provided to different entities in different ways. For instance, the configuration entity/sensing function 1202 can provide QCL information 1216 including the second QCL condition based on sensing target properties to the sensing Rx entity 1206 and/or the sensing Rx entity 1208. In another example, the sensing Tx entity 1204 can provide QCL information 1218 including the second QCL condition based on sensing target properties to different entities, including the configuration entity/sensing function 1202, the sensing Rx entity 1206, and/or the sensing Rx entity 1208. The second QCL condition included in the QCL information 1216, 1218 can include different attributes of the sensing target 1210, such as RCS, reflective properties, target location information, target orientation, target mobility, and combinations thereof

FIG. 13 illustrates an example scenario 1300 for using the second QCL condition at different entities. The scenario 1300, for example, can be implemented concurrently with and/or as a continuation of the scenario 1200 where second QCL condition information is provided to and/or received at the sensing Rx entities 1206, 1208. The sensing Tx entity 1204 can transmit Tx beams 1302 and the sensing Rx entity 1206, sensing Rx entity 1208 can receive sensing Rx beams 1304. The sensing Tx beams 1302, for instance, are reflected off the sensing target 1210 and received by the sensing Rx entity 1206, sensing Rx entity 1208 as the sensing Rx beams 1304. In implementations, the sensing Tx beams 1302 and the sensing Rx beams 1304 represent second RS signals, e.g., RS2. In implementations, the sensing Rx entity 1206, sensing Rx entity 1208 can use information of the second QCL condition to correlate sensing target attributes of the sensing Rx beams 1304 to sensing target attributes of the sensing Rx beams 1214.

In implementations, target RCS information may include parameters which capture the signal power/energy from a sensing Tx entity at a sensing target and re-radiate the signal power/energy in an isotropic manner to the sensing Rx entity, including R, Eₛ, Eᵢ as captured in equation (1) above, mean RCS value, RCS probability distribution function (e.g., lognormal), incident/scattered angles of azimuth, zenith and/or elevation, and combinations thereof. The target location information may be coarse or fine, and include absolute horizontal/vertical location, relative horizontal/vertical location, relative direction of target to sensing Tx entity/sensing Rx entity, range between target and sensing Tx entity/sensing Rx entity, and combinations thereof. The target orientation information may include the orientation in LCS/GCS. The target mobility information may include absolute horizontal/vertical velocity, relative horizontal/vertical velocity, stationary in which the velocity is zero, translational velocities, radial velocities, and combinations thereof.

In implementations, a new QCL type may be defined based on a combination of the conditions described in the first QCL and second QCL condition introduced above. Alternatively, or additionally, a new QCL type may be defined based on the various implementations described herein, e.g., based on a combination of the conditions described in QCL Types A, B, C, D, E (first QCL condition) and F (second QCL condition). According one or more examples, a reflected source RS (RS1) off a sensing target may be associated via QCL to subsequent delay paths relative to the dominant/LOS reflected signal path, which may be earlier or later with the respect to the dominant/LOS reflected signal path. In such examples, a configuration may further indicate which of the reflected non-LOS/dominant delay paths the source RS is associated with.

In implementations, the QCL types described herein and/or associations between two radiation pattens can be indicated with respect to a combination of a sensing target and/or an area of interest for sensing and a physical segment description of the sensing target and/or area of interest. In some such examples, the segmentation can include a range of sweeping parameters (e.g., defined steps in x, y direction) according to the GCS, or to the LCS of the sensing Tx entity and/or sensing Rx entity. In some examples, the segmentation can be defined in zenith/elevation domain. In some examples, the segmentation can be defined according to a known target segmentation pattern, e.g., human body parts or vehicle physical segments.

Implementations include sensing Rx procedures with QCL indication TCI state configuration. For instance, a TCI state framework is enhanced to support QCL conditions in the context of sensing. The TCI state framework includes signaling indications and/or transfer of QCL-related information to different entities, such as described with reference to FIGS. 10-13. Table 5 describes example source RSs for DL, UL, SL.

TABLE 5

| Downlink | Uplink | UE-UE Link, e.g., Sidelink |
|---|---|---|
| SS/PBCH | MIMO SRS | SL-PRS |
| Block/Synchronization RS | | |
| CSI-RS | SRS for positioning | SL-CSI |
| DL-PRS | SRS for sensing | Physical sidelink shared |
| | | channel (PSSCH) DM-RS |
| TRS | New RS for UL | Physical sidelink control |
| | | channel (PSCCH) DM-RS |
| PT-RS | | New RS for UE-UE links |
| DM-RS PDCCH | | |
| DM-RS PDSCH | | |
| New Sensing Reference Signal | | |

In implementations, a TCI state configuration includes one or more source RSs for different QCL associations, which may be used if particular QCL conditions (e.g., Type A-E) are not captured by a single source RS. In such implementations, the one or more source RSs may be configured to a UE prior to configuring a TCI state. Table 6 illustrates different TCI state configurations that may be signaled to a sensing Rx entity for a new sensing RS for periodic and aperiodic sensing RS transmissions. One or more QCL conditions may be selected from QCL Type Set 1 and one or more QCL conditions may be selected from QCL Type Set 2, such that the selected QCL Type(s) for DL RS1 and DL RS2 are non-overlapping if DL RS1 and DL RS2 are the same RS. In another implementation, the TCI state configuration may include one source RS1 and QCL type.

TABLE 6
Periodic/Aperiodic New Sensing RS

| TCI State | | QCL-Type | DL RS 2 (if | QCL-Type |
|---|---|---|---|---|
| Configuration | DL RS 1 | Set 1 | applicable) | Set 2 |
| 1 | SS/PBCH | {Type A, | SS/PBCH | {Type A, |
| | Block | Type B, | Block | Type B, |
| | | Type C, | | Type C, |
| | | Type D, | | Type D, |
| | | Type E, | | Type E, |
| | | Type F} | | Type F} |
| 2 | SS/PBCH | {Type A, | CSI-RS for | {Type A, |
| | Block | Type B, | all types | Type B, |
| | | Type C, | (e.g., | Type C, |
| | | Type D, | mobility, | Type D, |
| | | Type E, | beam | Type E, |
| | | Type F} | management, | Type F} |
| | | | etc.) | |
| 3 | CSI-RS for | {Type A, | SS/PBCH | {Type A, |
| | all types | Type B, | Block | Type B, |
| | (e.g., | Type C, | | Type C, |
| | mobility, | Type D, | | Type D, |
| | beam | Type E, | | Type E, |
| | management, | Type F} | | Type F} |
| | etc.) | | | |
| 4 | SS/PBCH | {Type A, | DL-PRS | {Type A, |
| | Block | Type B, | | Type B, |
| | | Type C, | | Type C, |
| | | Type D, | | Type D, |
| | | Type E, | | Type E, |
| | | Type F} | | Type F} |
| 5 | DL-PRS | {Type A, | DL-PRS | {Type A, |
| | | Type B, | | Type B, |
| | | Type C, | | Type C, |
| | | Type D, | | Type D, |
| | | Type E, | | Type E, |
| | | Type F} | | Type F} |
| 6 | New Sensing | {Type A, | New Sensing | {Type A, |
| | RS | Type B, | RS | Type B, |
| | | Type C, | | Type C, |
| | | Type D, | | Type D, |
| | | Type E, | | Type E, |
| | | Type F} | | Type F} |

In implementations, Table 6 may be extended to include a third source RS (e.g., RS3), such that each source RS describes the QCL relationship for each frequency range, e.g., source RS1 (e.g., DL RS1) corresponds to FR1, Source RS2 (e.g., DL RS2) corresponds to FR2, Source RS3 (e.g., DL RS3) corresponds to FR 3, etc. The example may list the source RS in any order corresponding to a particular FR.

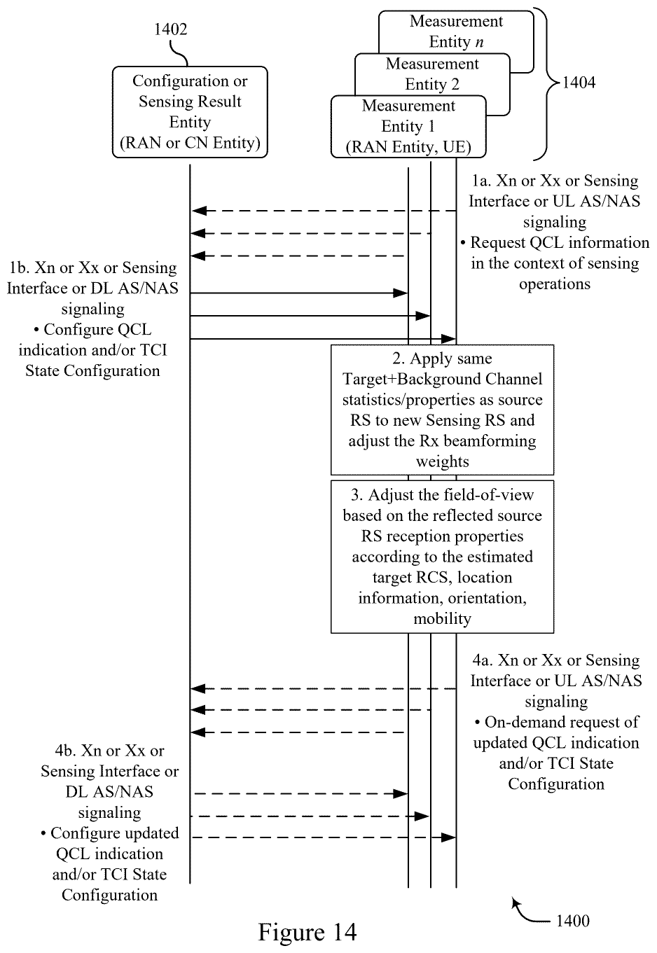

FIG. 14 illustrates an example signaling diagram 1400 in accordance with aspects of the present disclosure. The signaling diagram 1400, for instance, illustrates example procedures for configuring the new QCL indications and/or TCI state configurations applicable to a new sensing RS. In implementations, the same QCL indications may be applied for RS that may be used for sensing purposes, e.g., DL-PRS.

The signaling diagram 1400 includes a configuration or sensing result entity 1402 and measurement entities 1404, e.g., sensing Rx entities. The configuration or sensing result entity 1402 can represent an entity that configures a measurement entity 1404 with various configuration and/or sensing parameters described herein. Alternatively, or additionally, the configuration or sensing result entity 1402 can represent an entity that performs sensing result computation, such as based on sensing measurements received from the measurement entities 1404. The configuration or sensing result entity 1402 can be implemented in various ways, such as a RAN entity or a CN entity. The measurement entities 1404 can represent sensing Rx entities that are configured with sensing configuration information and/or parameters such as described herein, and may be implemented as RAN entities and/or UEs. The measurement entities 1404 can receive different types of RS, perform measurements on the RS, and transmit the measurements to different entities such as the configuration or sensing result entity 1402. The signaling diagram 1400 includes the following steps:
Step 1: A measurement entity 1404 (e.g., NE, NG-RAN/xG-RAN node, base station, gNB/xNB, UE acting as a sensing Rx entity) may request one or more QCL information/conditions or TCI State configurations, such as if triggered by the measurement entity 1404. The configuration or sensing result entity 1402 (e.g., RAN entity, CN entity (e.g., SF, LMF)) may provide QCL indications or TCI state configurations, which are applicable to the RS used for sensing purposes, e.g., new Sensing RS, DL-PRS.
Step 1a: A measurement entity 1404 (e.g., NE, NG-RAN/xG-RAN node, base station, gNB/xNB, UE acting as a sensing Rx entity) may request one or more QCL information/conditions or TCI state configurations, such as if triggered by the measurement entity 1404. In the case of a RAN entity request, Xn or Xx or a new sensing interface between a RAN entity and CN for sensing purposes may be used to carry an information request message. In the case of a UE request, an UL access stratum (AS) or non-access stratum (NAS) messages may be used to carry an information request message. In implementations, NAS signaling may include a new sensing protocol or existing LTE positioning protocol (LPP) to carry such a request, while in other implementations lower layer AS messages such as UL radio resource control (RRC) may be used. In implementations, lower layer messages such as uplink control information (UCI), physical uplink control channel (PUCCH), UL medium access control (MAC) control element (CE) may be used to convey this request.
Step 1b: The configuration or sensing result entity 1402 (e.g., RAN entity or CN entity, e.g., SF, LMF) may provision to the measurement entity 1404 the requested QCL information and/or TCI state configuration. In the case of a RAN entity, Xn or Xx or a new sensing interface between a RAN entity and CN for sensing purposes may be used to carry this configuration message. In the case of a UE, DL AS or NAS messages may be used to carry a configuration message. In at least one implementation, NAS signaling may include a new sensing protocol or existing LPP to carry such configuration information, while in other implementations lower layer AS messages such as DL RRC may be used. In other implementations, lower layer messages such as downlink control information (DCI), PDCCH, DL MAC CE may be used to convey this configuration information.
Step 2: The measurement entity 1404 has information of the same target and background channel statistics/properties and/or receiver beamforming weights which were applied to a previously configured/received RS (e.g., source RS as illustrated in Tables 5, 6) and the measurement entity 1404 may apply the information to the reception of a configured RS used for sensing purposes, e.g., new sensing RS or DL-PRS.
Step 3: The measurement entity 1404 may adjust the scan limit information and/or field-of-view information based on the reflected source RS reception properties. In implementations, this adjustment can be performed according to the target characteristics, e.g., target RCS information, target mobility, target location information, target orientation.
Step 4: Enables the measurement entity 1404 to request an update of the QCL information/conditions and/or TCI state configuration in an on-demand manner according to changes in the target characteristics.
Step 4a: The measurement entity 1404 (e.g., RAN entity (e.g., NG-RAN/xG-RAN node), base station, gNB/xNB, or UE acting as a sensing Rx entity) may request one or more updated QCL information/conditions or updated TCI state configurations, such as if triggered by the measurement entity 1404. In the case of a RAN entity request, Xn or Xx or a new sensing interface between a RAN entity and CN for sensing purposes may be used to carry an on-demand/updated configuration information request message. In the case of a UE request, UL AS or NAS messages may be used to carry this on-demand/updated configuration request message. In at least one implementation, UL NAS signaling may include a new sensing protocol or existing LPP to carry such a request, while in other implementations lower layer UL AS messages such as UL RRC may be used. In other implementations, lower layer messages such as UCI, PUCCH, UL MAC CE may be used to convey this on-demand/update request.
Step 4b: The configuration or sensing result entity 1402 (e.g., RAN entity or CN entity, e.g., SF, LMF) may provision on-demand/updated QCL information and/or TCI state configuration. In the case of a RAN entity, Xn or Xx or a new sensing interface between a RAN entity and CN for sensing purposes may be used to carry this on-demand/updated configuration message. In the case of a UE, DL AS or NAS message may be used to carry this on-demand/updated configuration message. In at least one implementation, NAS signaling may include a new sensing protocol or existing LPP to carry such on-demand/updated configuration information, while in other implementations lower layer AS messages such as DL RRC may be used. In other implementations, lower layer messages such as DCI, PDCCH, DL MAC CE may be used to convey this on-demand/updated configuration information.

In implementations, a multi-TCI state configuration may be signaled from the configuration or sensing result entity 1402, which may extend or be applicable to one or more sensing Tx entities, e.g., multi-TRP scenario, coordinated multi-point transmissions (CoMP). According to implementations described herein, the QCL information/indications can be derived from the perspective one sensing Tx entity, e.g., base station/single TRP. However, implementations may support signaling of QCL information and/or TCI state configurations applicable to one or more sensing Tx entities to a measurement entity 1404.

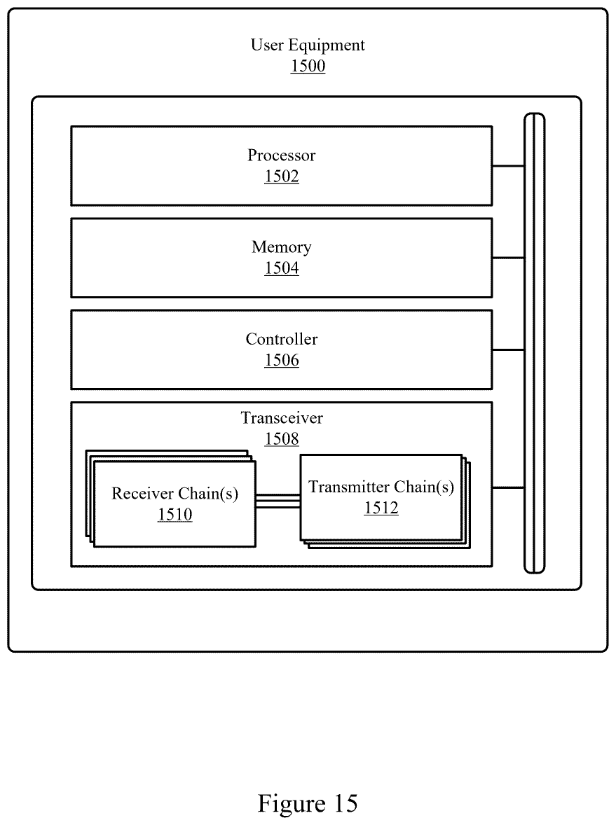

FIG. 15 illustrates an example of a UE 1500 in accordance with aspects of the present disclosure. The UE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the UE 1500 to perform various functions of the present disclosure.

The memory 1504 may include volatile or non-volatile memory. The memory 1504 may store computer-readable, computer-executable code including instructions when executed by the processor 1502 cause the UE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the UE 1500 to perform one or more of the functions described herein (e.g., executing, by the processor 1502, instructions stored in the memory 1504). For example, the processor 1502 may support wireless communication at the UE 1500 in accordance with examples as disclosed herein. The UE 1500 may be configured to or operable to support a means for receiving configuration information indicating QCL relationship information between a source reference signal and a sensing reference signal; receiving the sensing reference signal based at least in part on a receive antenna configuration, where the receive antenna configuration is based at least in part on the configuration information including the QCL relationship information; and performing at least one sensing measurement based at least in part on the sensing reference signal.

Additionally, the UE 1500 may be configured to support any one or combination of where the configuration information includes QCL relationship information for one or more of QCL type A, QCL type B, QCL type C, or QCL type D; the configuration information indicates one or more of: a first QCL type based at least in part on one or more of a spatial reception parameter, a spatial area, or a field-of-view parameter; or a second QCL type based at least in part on one or more of the spatial reception parameter, a target radar cross section, a target location information, a target orientation parameter, or a target mobility; the QCL relationship information is based at least in part on one or more of: a source reference signal of at least one of a dominant reflected signal path or a line of sight reflected signal path associated with a sensing target; or one or more reflected delay paths relative to a dominant reflected signal path or a line of sight reflected signal path associated with a sensing target; the source reference signal includes one or more downlink reference signals including one or more of a SSB reference signal, a PSS, a SSS, a CSI-RS, a DL-PRS, a TRS, a PT-RS, a DM-RS PDCCH, or a DM-RS PDSCH or downlink reference signal used for sensing.

Additionally, the UE 1500 may be configured to support any one or combination of where the source reference signal includes one or more uplink reference signals including one or more of MIMO SRS, a positioning SRS, a sensing SRS, or an uplink reference signal; the source reference signal includes one or more sidelink reference signals including one or more of a SL-PRS, a SL-CSI, or a reference signal for a UE-UE link; further including receiving TCI configuration including one or more source reference signals with different QCL associations; further including receiving TCI configuration including one or more source reference signals with different QCL associations defined based at least in part on frequency range of operation; further including: requesting updated QCL information for sensing; and receiving, in response to the requesting, the updated QCL information for sensing.

Additionally, or alternatively, the UE 1500 may support at least one memory (e.g., the memory 1504) and at least one processor (e.g., the processor 1502) coupled with the at least one memory and configured to cause the UE to receive configuration information indicating QCL relationship information between a source reference signal and a sensing reference signal; receive the sensing reference signal based at least in part on a receive antenna configuration, where the receive antenna configuration is based at least in part on the configuration information including the QCL relationship information; and perform at least one sensing measurement based at least in part on the sensing reference signal.

Additionally, the UE 1500 may be configured to support any one or combination of where the configuration information includes QCL relationship information for one or more of QCL type A, QCL type B, QCL type C, or QCL type D; the configuration information indicates one or more of: a first QCL type based at least in part on one or more of a spatial reception parameter, a spatial area, or a field-of-view parameter; or a second QCL type based at least in part on one or more of the spatial reception parameter, a target radar cross section, a target location information, a target orientation parameter, or a target mobility; the QCL relationship information is based at least in part on one or more of: a source reference signal of at least one of a dominant reflected signal path or a line of sight reflected signal path associated with a sensing target; or one or more reflected delay paths relative to a dominant reflected signal path or a line of sight reflected signal path associated with a sensing target; the source reference signal includes one or more downlink reference signals including one or more of a SSB reference signal, a PSS, a SSS, a CSI-RS, a downlink positioning reference signal (DL-PRS), a TRS, a PT-RS, a DM-RS PDCCH, or a DM-RS PDSCH or downlink reference signal used for sensing.

Additionally, the UE 1500 may be configured to support any one or combination of where the source reference signal includes one or more uplink reference signals including one or more of MIMO SRS, a positioning SRS, a sensing SRS, or an uplink reference signal; the source reference signal includes one or more sidelink reference signals including one or more of a SL-PRS, a SL-CSI, or a reference signal for a UE-UE link; the at least one processor is configured to cause the UE to receive TCI configuration including one or more source reference signals with different QCL associations; the at least one processor is configured to cause the UE to receive TCI configuration including one or more source reference signals with different QCL associations defined based at least in part on frequency range of operation; the at least one processor is configured to cause the UE to one or more of: request updated QCL information for sensing; and receive, in response to the requesting, the updated QCL information for sensing.

The controller 1506 may manage input and output signals for the UE 1500. The controller 1506 may also manage peripherals not integrated into the UE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the UE 1500 may include at least one transceiver 1508. In some other implementations, the UE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

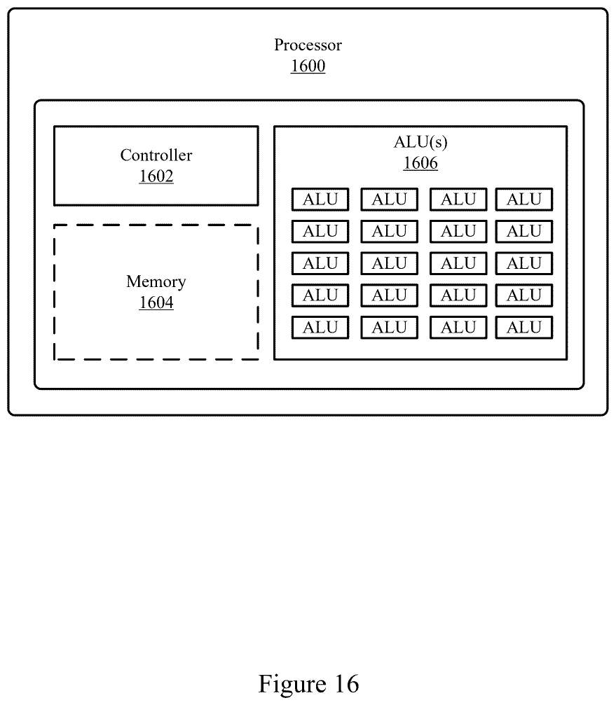

FIG. 16 illustrates an example of a processor 1600 in accordance with aspects of the present disclosure. The processor 1600 may be an example of a processor configured to perform various operations in accordance with examples as described herein. The processor 1600 may include a controller 1602 configured to perform various operations in accordance with examples as described herein. The processor 1600 may optionally include at least one memory 1604, which may be, for example, an L1/L2/L3 cache. Additionally, or alternatively, the processor 1600 may optionally include one or more arithmetic-logic units (ALUs) 1606. One or more of these components may be in electronic communication or otherwise coupled (e.g., operatively, communicatively, functionally, electronically, electrically) via one or more interfaces (e.g., buses).

The processor 1600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1602 may be configured to manage and coordinate various operations (e.g., signaling, receiving, obtaining, retrieving, transmitting, outputting, forwarding, storing, determining, identifying, accessing, writing, reading) of the processor 1600 to cause the processor 1600 to support various operations in accordance with examples as described herein. For example, the controller 1602 may operate as a control unit of the processor 1600, generating control signals that manage the operation of various components of the processor 1600. These control signals include enabling or disabling functional units, selecting data paths, initiating memory access, and coordinating timing of operations.

The controller 1602 may be configured to fetch (e.g., obtain, retrieve, receive) instructions from the memory 1604 and determine subsequent instruction(s) to be executed to cause the processor 1600 to support various operations in accordance with examples as described herein. The controller 1602 may be configured to track memory addresses of instructions associated with the memory 1604. The controller 1602 may be configured to decode instructions to determine the operation to be performed and the operands involved. For example, the controller 1602 may be configured to interpret the instruction and determine control signals to be output to other components of the processor 1600 to cause the processor 1600 to support various operations in accordance with examples as described herein. Additionally, or alternatively, the controller 1602 may be configured to manage flow of data within the processor 1600. The controller 1602 may be configured to control transfer of data between registers, ALUs 1606, and other functional units of the processor 1600.

The memory 1604 may include one or more caches (e.g., memory local to or included in the processor 1600 or other memory, such as RAM, ROM, DRAM, SDRAM, SRAM, MRAM, flash memory, etc. In some implementations, the memory 1604 may reside within or on a processor chipset (e.g., local to the processor 1600). In some other implementations, the memory 1604 may reside external to the processor chipset (e.g., remote to the processor 1600).

The memory 1604 may store computer-readable, computer-executable code including instructions that, when executed by the processor 1600, cause the processor 1600 to perform various functions described herein. The code may be stored in a non-transitory computer-readable medium such as system memory or another type of memory. The controller 1602 and/or the processor 1600 may be configured to execute computer-readable instructions stored in the memory 1604 to cause the processor 1600 to perform various functions. For example, the processor 1600 and/or the controller 1602 may be coupled with or to the memory 1604, the processor 1600, and the controller 1602, and may be configured to perform various functions described herein. In some examples, the processor 1600 may include multiple processors and the memory 1604 may include multiple memories. One or more of the multiple processors may be coupled with one or more of the multiple memories, which may, individually or collectively, be configured to perform various functions herein.

The one or more ALUs 1606 may be configured to support various operations in accordance with examples as described herein. In some implementations, the one or more ALUs 1606 may reside within or on a processor chipset (e.g., the processor 1600). In some other implementations, the one or more ALUs 1606 may reside external to the processor chipset (e.g., the processor 1600). One or more ALUs 1606 may perform one or more computations such as addition, subtraction, multiplication, and division on data. For example, one or more ALUs 1606 may receive input operands and an operation code, which determines an operation to be executed. One or more ALUs 1606 may be configured with a variety of logical and arithmetic circuits, including adders, subtractors, shifters, and logic gates, to process and manipulate the data according to the operation. Additionally, or alternatively, the one or more ALUs 1606 may support logical operations such as AND, OR, exclusive-OR (XOR), not-OR (NOR), and not-AND (NAND), enabling the one or more ALUs 1606 to handle conditional operations, comparisons, and bitwise operations.

The processor 1600 may support wireless communication in accordance with examples as disclosed herein. The processor 1600 may be configured to or operable to support at least one controller (e.g., the controller 1602) coupled with at least one memory (e.g., the memory 1604) and configured to cause the processor to receive configuration information indicating QCL relationship information between a source reference signal and a sensing reference signal; receive the sensing reference signal based at least in part on a receive antenna configuration, where the receive antenna configuration is based at least in part on the configuration information including the QCL relationship information; and perform at least one sensing measurement based at least in part on the sensing reference signal.

Additionally, the processor 1600 may be configured to or operable to support any one or combination of where the configuration information includes QCL relationship information for one or more of QCL type A, QCL type B, QCL type C, or QCL type D; the configuration information indicates one or more of: a first QCL type based at least in part on one or more of a spatial reception parameter, a spatial area, or a field-of-view parameter; or a second QCL type based at least in part on one or more of the spatial reception parameter, a target radar cross section, a target location information, a target orientation parameter, or a target mobility; the QCL relationship information is based at least in part on one or more of: a source reference signal of at least one of a dominant reflected signal path or a line of sight reflected signal path associated with a sensing target; or one or more reflected delay paths relative to a dominant reflected signal path or a line of sight reflected signal path associated with a sensing target; the source reference signal includes one or more downlink reference signals including one or more of a SSB reference signal, a PSS, a SSS, a CSI-RS, a DL-PRS, a TRS, a PT-RS, a DM-RS PDCCH, or a DM-RS PDSCH.

Additionally, the processor 1600 may be configured to or operable to support any one or combination of where the source reference signal includes one or more uplink reference signals including one or more of MIMO SRS, a positioning SRS, a sensing SRS, or an uplink reference signal; the source reference signal includes one or more sidelink reference signals including one or more of a SL-PRS, a SL-CSI, or a reference signal for a UE-UE link; the at least one controller is configured to cause the processor to receive TCI configuration including one or more source reference signals with different QCL associations; the at least one processor is configured to cause the UE to receive TCI configuration including one or more source reference signals with different QCL associations defined based at least in part on frequency range of operation; the at least one controller is configured to cause the processor to one or more of: request updated QCL information for sensing; and receive, in response to the requesting, the updated QCL information for sensing.

Additionally, the processor 1600 may be configured to or operable to support any one or combination of where the configuration information includes QCL relationship information for one or more of QCL type A, QCL type B, QCL type C, or QCL type D; the configuration information indicates one or more of: a first QCL type based at least in part on one or more of a spatial reception parameter, a spatial area, or a field-of-view parameter; or a second QCL type based at least in part on one or more of the spatial reception parameter, a target radar cross section, a target location information, a target orientation parameter, or a target mobility; the QCL relationship information is based at least in part on one or more of: a source reference signal of at least one of a dominant reflected signal path or a line of sight reflected signal path associated with a sensing target; or one or more reflected delay paths relative to a dominant reflected signal path or a line of sight reflected signal path associated with a sensing target; the at least one controller is configured to cause the processor to receive TCI configuration including one or more source reference signals with different QCL associations; the at least one controller is configured to cause the processor to receive TCI configuration including one or more source reference signals with different QCL associations defined based at least in part on frequency range of operation; the at least one controller is configured to cause the processor to request updated QCL information for sensing; and receive, in response to the requesting, the updated QCL information for sensing.

The processor 1600 may support wireless communication in accordance with examples as disclosed herein. The processor 1600 may be configured to or operable to support at least one controller (e.g., the controller 1602) coupled with at least one memory (e.g., the memory 1604) and configured to cause the processor to transmit configuration information indicating QCL relationship information between a source reference signal and a sensing reference signal.

Additionally, the processor 1600 may be configured to or operable to support any one or combination of where the at least one controller is configured to cause the processor to transmit the source reference signal; and transmit the sensing reference signal based at least in part on the configuration information including the QCL relationship information.

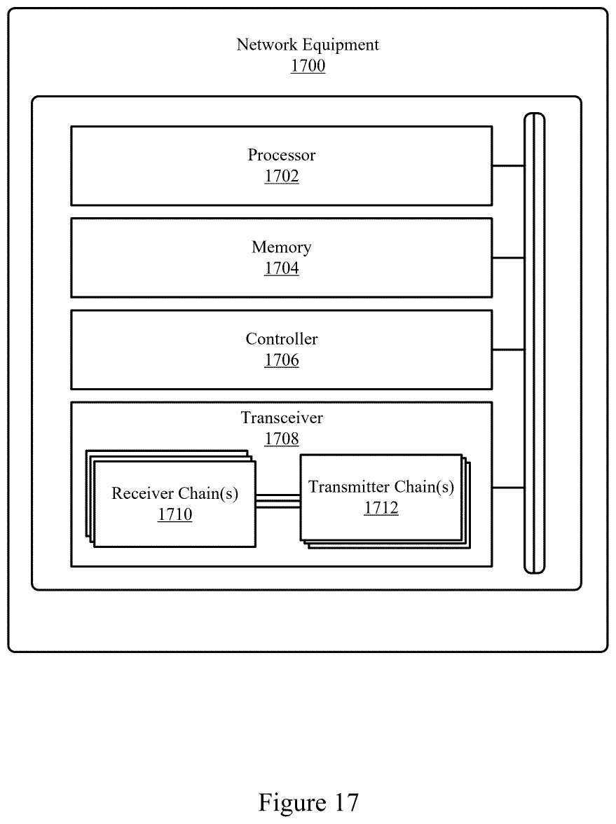

FIG. 17 illustrates an example of a NE 1700 in accordance with aspects of the present disclosure. The NE 1700 may include a processor 1702, a memory 1704, a controller 1706, and a transceiver 1708. The processor 1702, the memory 1704, the controller 1706, or the transceiver 1708, or various combinations thereof or various components thereof may be examples of means for performing various aspects of the present disclosure as described herein. These components may be coupled (e.g., operatively, communicatively, functionally, electronically, electrically) via one or more interfaces.

The processor 1702, the memory 1704, the controller 1706, or the transceiver 1708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1702 may include an intelligent hardware device (e.g., a general-purpose processor, a DSP, a CPU, an ASIC, an FPGA, or any combination thereof). In some implementations, the processor 1702 may be configured to operate the memory 1704. In some other implementations, the memory 1704 may be integrated into the processor 1702. The processor 1702 may be configured to execute computer-readable instructions stored in the memory 1704 to cause the NE 1700 to perform various functions of the present disclosure.

The memory 1704 may include volatile or non-volatile memory. The memory 1704 may store computer-readable, computer-executable code including instructions when executed by the processor 1702 cause the NE 1700 to perform various functions described herein. The code may be stored in a non-transitory computer-readable medium such as the memory 1704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1702 and the memory 1704 coupled with the processor 1702 may be configured to cause the NE 1700 to perform one or more of the functions described herein (e.g., executing, by the processor 1702, instructions stored in the memory 1704).

For example, the processor 1702 may support wireless communication at the NE 1700 in accordance with examples as disclosed herein. The NE 1700 may be configured to or operable to support a means for receiving configuration information indicating QCL relationship information between a source reference signal and a sensing reference signal; receiving the sensing reference signal based at least in part on a receive antenna configuration, where the receive antenna configuration is based at least in part on the configuration information including the QCL relationship information; and performing at least one sensing measurement based at least in part on the sensing reference signal.

Additionally, the NE 1700 may be configured to or operable to support any one or combination of where the configuration information includes QCL relationship information for one or more of QCL type A, QCL type B, QCL type C, or QCL type D; the configuration information indicates one or more of: a first QCL type based at least in part on one or more of a spatial reception parameter, a spatial area, or a field-of-view parameter; or a second QCL type based at least in part on one or more of the spatial reception parameter, a target radar cross section, a target location information, a target orientation parameter, or a target mobility; the QCL relationship information is based at least in part on one or more of: a source reference signal of at least one of a dominant reflected signal path or a line of sight reflected signal path associated with a sensing target; or one or more reflected delay paths relative to a dominant reflected signal path or a line of sight reflected signal path associated with a sensing target; receiving TCI configuration including one or more source reference signals with different QCL associations; receiving TCI configuration including one or more source reference signals with different QCL associations defined based at least in part on frequency range of operation; requesting updated QCL information for sensing; and receiving, in response to the requesting, the updated QCL information for sensing.

Additionally, or alternatively, the NE 1700 may support at least one memory (e.g., the memory 1704) and at least one processor (e.g., the processor 1702) coupled with the at least one memory and configured to cause the NE to receive configuration information indicating QCL relationship information between a source reference signal and a sensing reference signal; receive the sensing reference signal based at least in part on a receive antenna configuration, where the receive antenna configuration is based at least in part on the configuration information including the QCL relationship information; and perform at least one sensing measurement based at least in part on the sensing reference signal.

Additionally, the NE 1700 may be configured to support any one or combination of where the configuration information includes QCL relationship information for one or more of QCL type A, QCL type B, QCL type C, or QCL type D; the configuration information indicates one or more of: a first QCL type based at least in part on one or more of a spatial reception parameter, a spatial area, or a field-of-view parameter; or a second QCL type based at least in part on one or more of the spatial reception parameter, a target radar cross section, a target location information, a target orientation parameter, or a target mobility; the QCL relationship information is based at least in part on one or more of: a source reference signal of at least one of a dominant reflected signal path or a line of sight reflected signal path associated with a sensing target; or one or more reflected delay paths relative to a dominant reflected signal path or a line of sight reflected signal path associated with a sensing target; the at least one processor is configured to cause the NE to receive TCI configuration including one or more source reference signals with different QCL associations; the at least one processor is configured to cause the NE to receive TCI configuration including one or more source reference signals with different QCL associations defined based at least in part on frequency range of operation; the at least one processor is configured to cause the NE to one or more of: request updated QCL information for sensing; and receive, in response to the requesting, the updated QCL information for sensing.

For example, the processor 1702 may support wireless communication at the NE 1700 in accordance with examples as disclosed herein. The NE 1700 may be configured to or operable to support a means for transmitting configuration information indicating QCL relationship information between a source reference signal and a sensing reference signal.

Additionally, the NE 1700 may be configured to or operable to support any one or combination of where the at least one processor is configured to cause the NE to: transmit the source reference signal; and transmit the sensing reference signal based at least in part on the configuration information including the QCL relationship information.

Additionally, or alternatively, the NE 1700 may support at least one memory (e.g., the memory 1704) and at least one processor (e.g., the processor 1702) coupled with the at least one memory and configured to cause the NE to transmit configuration information indicating QCL relationship information between a source reference signal and a sensing reference signal.

Additionally, the NE 1700 may be configured to support any one or combination of where the at least one processor is configured to cause the NE to: transmit the source reference signal; and transmit the sensing reference signal based at least in part on the configuration information including the QCL relationship information.

The controller 1706 may manage input and output signals for the NE 1700. The controller 1706 may also manage peripherals not integrated into the NE 1700. In some implementations, the controller 1706 may utilize an operating system such as iOS®, ANDROID®, WINDOWS®, or other operating systems. In some implementations, the controller 1706 may be implemented as part of the processor 1702.

In some implementations, the NE 1700 may include at least one transceiver 1708. In some other implementations, the NE 1700 may have more than one transceiver 1708. The transceiver 1708 may represent a wireless transceiver. The transceiver 1708 may include one or more receiver chains 1710, one or more transmitter chains 1712, or a combination thereof.

A receiver chain 1710 may be configured to receive signals (e.g., control information, data, packets) over a wireless medium. For example, the receiver chain 1710 may include one or more antennas to receive a signal over the air or wireless medium. The receiver chain 1710 may include at least one amplifier (e.g., a low-noise amplifier (LNA)) configured to amplify the received signal. The receiver chain 1710 may include at least one demodulator configured to demodulate the receive signal and obtain the transmitted data by reversing the modulation technique applied during transmission of the signal. The receiver chain 1710 may include at least one decoder for decoding the demodulated signal to receive the transmitted data.

A transmitter chain 1712 may be configured to generate and transmit signals (e.g., control information, data, packets). The transmitter chain 1712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1712 may also include at least one power amplifier configured to amplify the modulated signal to an appropriate power level suitable for transmission over the wireless medium. The transmitter chain 1712 may also include one or more antennas for transmitting the amplified signal into the air or wireless medium.

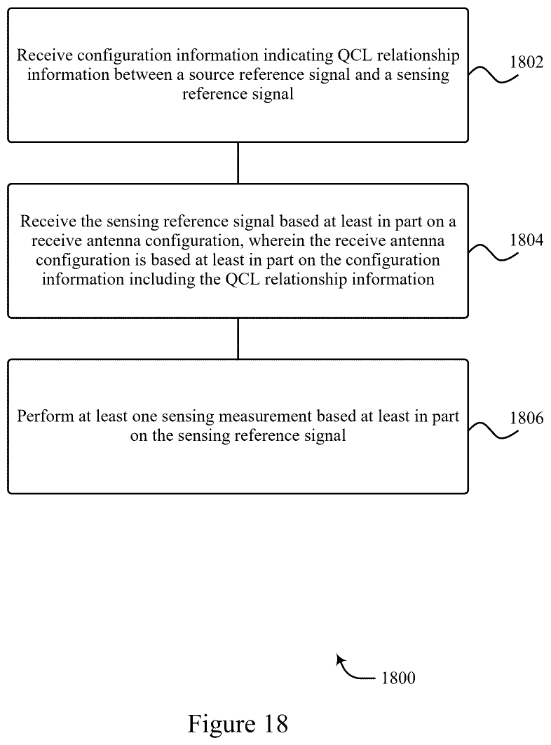

FIG. 18 illustrates a flowchart of a method 1800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1802, the method may include receiving configuration information indicating QCL relationship information between a source reference signal and a sensing reference signal. The operations of 1802 may be performed in accordance with examples as described herein. In some implementations, aspects of the operations of 1802 may be performed by a UE as described with reference to FIG. 15.

At 1804, the method may include receiving the sensing reference signal based at least in part on a receive antenna configuration, where the receive antenna configuration is based at least in part on the configuration information including the QCL relationship information. The operations of 1804 may be performed in accordance with examples as described herein. In some implementations, aspects of the operations of 1804 may be performed by a UE as described with reference to FIG. 15.

At 1806, the method may include perform at least one sensing measurement based at least in part on the sensing reference signal. The operations of 1806 may be performed in accordance with examples as described herein. In some implementations, aspects of the operations of 1806 may be performed a UE as described with reference to FIG. 15.

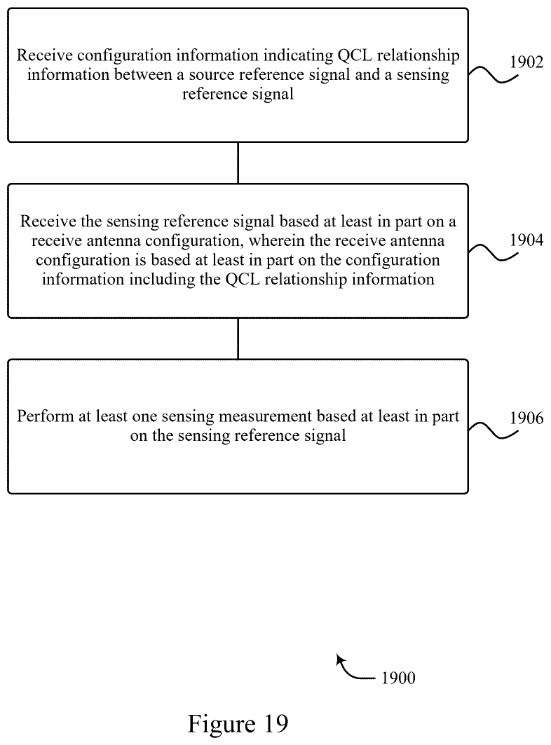

FIG. 19 illustrates a flowchart of a method 1900 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1902, the method may include receiving configuration information indicating QCL relationship information between a source reference signal and a sensing reference signal. The operations of 1902 may be performed in accordance with examples as described herein. In some implementations, aspects of the operations of 1902 may be performed by a NE as described with reference to FIG. 17.

At 1904, the method may include receiving the sensing reference signal based at least in part on a receive antenna configuration, where the receive antenna configuration is based at least in part on the configuration information including the QCL relationship information. The operations of 1904 may be performed in accordance with examples as described herein. In some implementations, aspects of the operations of 1904 may be performed by a NE as described with reference to FIG. 17.

At 1906, the method may include performing at least one sensing measurement based at least in part on the sensing reference signal. The operations of 1906 may be performed in accordance with examples as described herein. In some implementations, aspects of the operations of 1906 may be performed a NE as described with reference to FIG. 17.

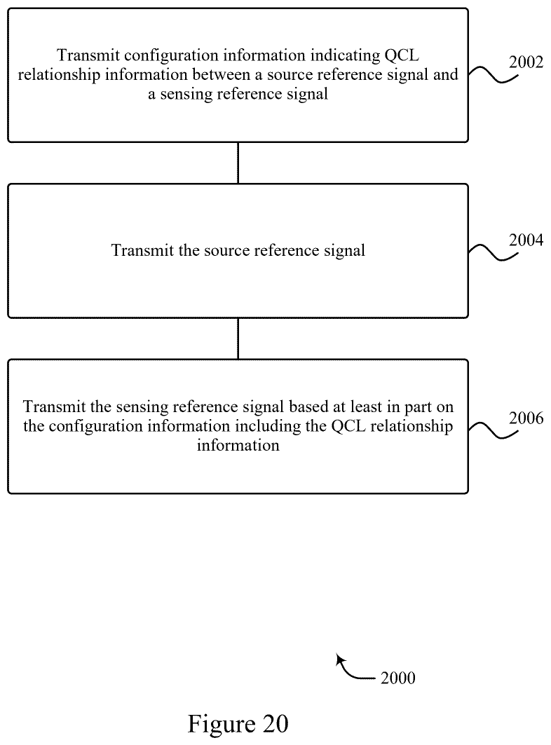

FIG. 20 illustrates a flowchart of a method 2000 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 2002, the method may include transmitting configuration information indicating QCL relationship information between a source reference signal and a sensing reference signal. The operations of 2002 may be performed in accordance with examples as described herein. In some implementations, aspects of the operations of 2002 may be performed by a NE as described with reference to FIG. 17.

At 2004, the method may include transmitting the source reference signal. The operations of 2004 may be performed in accordance with examples as described herein. In some implementations, aspects of the operations of 2004 may be performed by a NE as described with reference to FIG. 17.

At 2006, the method may include transmitting the sensing reference signal based at least in part on the configuration information including the QCL relationship information. The operations of 2006 may be performed in accordance with examples as described herein. In some implementations, aspects of the operations of 2006 may be performed a NE as described with reference to FIG. 17.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive configuration information indicating quasi-colocation (QCL) relationship information between a source reference signal and a sensing reference signal;
receive the sensing reference signal based at least in part on a receive antenna configuration, wherein the receive antenna configuration is based at least in part on the configuration information including the QCL relationship information; and
perform at least one sensing measurement based at least in part on the sensing reference signal.

2. The UE of claim 1, wherein the configuration information comprises QCL relationship information for one or more of QCL type A, QCL type B, QCL type C, or QCL type D.

3. The UE of claim 1, wherein the configuration information indicates one or more of:
a first QCL type based at least in part on one or more of a spatial reception parameter, a spatial area, or a field-of-view parameter; or
a second QCL type based at least in part on one or more of the spatial reception parameter, a target radar cross section, a target location information, a target orientation parameter, or a target mobility.

4. The UE of claim 1, wherein the QCL relationship information is based at least in part on one or more of:
a source reference signal of at least one of a dominant reflected signal path or a line of sight reflected signal path associated with a sensing target; or
one or more reflected delay paths relative to a dominant reflected signal path or a line of sight reflected signal path associated with a sensing target.

5. The UE of claim 1, wherein the source reference signal comprises one or more downlink reference signals comprising one or more of a synchronization signal/physical broadcast channel (SS/PBCH) block (SSB) reference signal, a primary synchronization signal (PSS), a secondary synchronization signal (SSS), a channel state information reference signal (CSI-RS), a downlink positioning reference signal (DL-PRS), a tracking reference signal (TRS), a phase tracking reference signal (PT-RS), a demodulation reference signal (DM-RS) physical downlink control channel (PDCCH), or a DM-RS physical downlink shared channel (PDSCH).

6. The UE of claim 1, wherein the source reference signal comprises one or more uplink reference signals comprising one or more of multiple input multiple output (MIMO) sounding reference signal (SRS), a positioning SRS, a sensing SRS, or an uplink reference signal.

7. The UE of claim 1, wherein the source reference signal comprises one or more sidelink reference signals comprising one or more of a sidelink positioning reference signal (SL-PRS), a sidelink channel state information (SL-CSI), or a reference signal for a UE-UE link.

8. The UE of claim 1, wherein the at least one processor is configured to cause the UE to receive transmission configuration indicator (TCI) configuration comprising one or more source reference signals with different QCL associations.

9. The UE of claim 1, wherein the at least one processor is configured to cause the UE to receive transmission configuration indicator (TCI) configuration comprising one or more source reference signals with different QCL associations defined based at least in part on frequency range of operation.

10. The UE of claim 1, wherein the at least one processor is configured to cause the UE to one or more of:
request updated QCL information for sensing; and
receive, in response to the requesting, the updated QCL information for sensing.

11. A processor for wireless communication, comprising:
at least one controller coupled with at least one memory and configured to cause the processor to:
receive configuration information indicating quasi-colocation (QCL) relationship information between a source reference signal and a sensing reference signal;
receive the sensing reference signal based at least in part on a receive antenna configuration, wherein the receive antenna configuration is based at least in part on the configuration information including the QCL relationship information; and
perform at least one sensing measurement based at least in part on the sensing reference signal.

12. A network equipment (NE) for wireless communication, comprising:
at least one memory; and
at least one processor coupled with the at least one memory and configured to cause the NE to:
receive configuration information indicating quasi-colocation (QCL) relationship information between a source reference signal and a sensing reference signal;
receive the sensing reference signal based at least in part on a receive antenna configuration, wherein the receive antenna configuration is based at least in part on the configuration information including the QCL relationship information; and
perform at least one sensing measurement based at least in part on the sensing reference signal.

13. The NE of claim 12, wherein the configuration information comprises QCL relationship information for one or more of QCL type A, QCL type B, QCL type C, or QCL type D.

14. The NE of claim 12, wherein the configuration information indicates one or more of:
a first QCL type based at least in part on one or more of a spatial reception parameter, a spatial area, or a field-of-view parameter; or
a second QCL type based at least in part on one or more of the spatial reception parameter, a target radar cross section, a target location information, a target orientation parameter, or a target mobility.

15. The NE of claim 12, wherein the QCL relationship information is based at least in part on one or more of:
a source reference signal of at least one of a dominant reflected signal path or a line of sight reflected signal path associated with a sensing target; or
one or more reflected delay paths relative to a dominant reflected signal path or a line of sight reflected signal path associated with a sensing target.

16. The NE of claim 12, wherein the at least one processor is configured to cause the NE to receive transmission configuration indicator (TCI) configuration comprising one or more source reference signals with different QCL associations.

17. The NE of claim 12, wherein the at least one processor is configured to cause the NE to receive transmission configuration indicator (TCI) configuration comprising one or more source reference signals with different QCL associations defined based at least in part on frequency range of operation.

18. The NE of claim 12, wherein the at least one processor is configured to cause the NE to one or more of:
request updated QCL information for sensing; and
receive, in response to the requesting, the updated QCL information for sensing.

19. A network equipment (NE) for wireless communication, comprising:
at least one memory; and
at least one processor coupled with the at least one memory and configured to cause the NE to:
transmit configuration information indicating quasi-colocation (QCL) relationship information between a source reference signal and a sensing reference signal.

20. The NE of claim 19, wherein the at least one processor is configured to cause the NE to:
transmit the source reference signal; and
transmit the sensing reference signal based at least in part on the configuration information including the QCL relationship information.
